(19) United States
(12) Patent Application Publication
(10) Pub. No.: US 2026/0213246 A1
(43) Pub. Date: Jul. 23, 2026

(54) LAYOUT OF BATTERY CELL ASSEMBLY APPARATUS AND OPERATING METHOD THEREOF

(71) Applicant: SK On Co., Ltd., Seoul (KR)

(72) Inventors: Hyeong Gyu KIM, Daejeon (KR); Ki Wook LEE, Daejeon (KR); Do Wan CHA, Daejeon (KR)

(21) Appl. No.: 19/450,731

(22) Filed: Jan. 16, 2026

(30) Foreign Application Priority Data
Jan. 20, 2025 (KR) 10-2025-0008285
Oct. 27, 2025 (KR) 10-2025-0156738

(51) Int. Cl. H01M 10/04; H01M 50/536

(52) U.S. Cl. CPC H01M 10/0404; H01M 10/049; H01M 50/536

(57) ABSTRACT

Proposed are a layout of a battery cell assembly apparatus and an operating method thereof. The layout comprises a first processing line for manufacturing a first-type electrode assembly, a second processing line for manufacturing a second-type electrode assembly, a stack line for manufacturing a double electrode assembly by stacking and fixing the first-type electrode assembly and the second-type electrode assembly output from the first processing line and the second processing line, a first insertion line for manufacturing a battery cell by inserting the double electrode assembly into a case, and a second insertion line for manufacturing a battery cell by inserting the double electrode assembly into a case, wherein the first processing line and the second processing line are arranged in parallel, and the first insertion line and the second insertion line are arranged in parallel to reduce a length of an entire line.

### CROSS REFERENCE TO RELATED APPLICATION

The present application claims priority to Korean Patent Application No. 10-2025-0008285, filed on January 20, 2025, and Korean Patent Application No. 10-2025-0156738, filed on October 27, 2025, the entire contents of which are incorporated herein for all purposes by this reference.

### TECHNICAL FIELD

The present disclosure relates to a layout of a battery cell assembly apparatus and an operating method thereof.

### BACKGROUND

A secondary battery is a battery rechargeable and dischargeable. The battery cell has a structure in which an electrode assembly with a positive electrode, a separator, and a negative electrode laminated therein is housed in a case. Battery cells can be classified into a pouch-type, prismatic-type, and cylindrical-type depending on the shape of the case. The assembly process of the battery cell is configured differently depending on the type of the battery cell. The size, number, and type of devices for assembling the battery cell also vary depending on the type of the battery cell. The assembly process of the battery cell comprises various devices such as a device for manufacturing the electrode assembly, a device for inserting the electrode assembly into the case, and a device for injecting an electrolyte into the case. The devices for assembling the battery cell are connected to one another along a production line to form a layout of an assembly apparatus.

### SUMMARY

According to an aspect of the present disclosure, there are provided a layout of a battery cell assembly apparatus and an operating method thereof, in which a plurality of assembly lines performing the same process are arranged in parallel, and when one assembly line is under inspection, the other assembly lines remain operable.

According to an aspect of the present disclosure, there are provided a layout of a battery cell assembly apparatus and an operating method thereof, in which a single assembly line of an electrode assembly is capable of manufacturing a plurality of different types of electrode assemblies.

A layout of a battery cell assembly apparatus and its operating method according to an aspect of the present disclosure can be applied to a manufacturing process of a battery which is widely used in green technology fields such as electric vehicles, battery charging stations, and solar power generation and wind power generation using batteries.

A layout of a battery cell assembly apparatus and its operating method according to an aspect of the present disclosure can be applied to a manufacturing process of a battery which is used in an eco-friendly electric vehicle, a hybrid vehicle, and the like to prevent climate change by suppressing air pollution and greenhouse gas emission.

According to an aspect of the present disclosure, a layout of a battery cell assembly apparatus comprises a first processing line for manufacturing a first-type electrode assembly, a second processing line for manufacturing a second-type electrode assembly, a stack line for manufacturing a double electrode assembly by stacking and fixing the first-type electrode assembly and the second-type electrode assembly output from the first processing line and the second processing line, a first insertion line for manufacturing a battery cell by inserting the double electrode assembly into a case, and a second insertion line for manufacturing a battery cell by inserting the double electrode assembly into a case, wherein the first processing line and the second processing line are arranged in parallel with each other, and the first insertion line and the second insertion line are arranged in parallel with each other in order to reduce a length of an entire line.

According to an embodiment of the present disclosure, processing speeds of the first processing line and the second processing line may be twice the processing speeds of the first insertion line and the second insertion line.

According to an embodiment of the present disclosure, the layout of the battery cell assembly apparatus may further comprise a first inspection line arranged alongside the first insertion line for inspecting the battery cell for a defect, and a second inspection line arranged alongside the second insertion line and arranged in parallel with the first inspection line for inspecting the battery cell for a defect.

According to an embodiment of the present disclosure, the first processing line may comprise a first welder for performing welding at a first position spaced apart from a first transfer table by a first distance to manufacture the first-type electrode assembly in a state in which an electrode assembly is seated on the first transfer table with an upper surface of the electrode assembly facing upward so that a welding tab is formed at a location closer to an upper surface than a lower surface of a body, and a first cutter for performing cutting at the first position in order to cut the welding tab to a predetermined length, and the second processing line may comprise a second welder for performing welding at the first position spaced apart from a second transfer table by the first distance to manufacture the second-type electrode assembly in a state in which the electrode assembly is seated on the second transfer table with a lower surface of the electrode assembly facing upward so that the welding tab is formed at a location closer to the lower surface than the upper surface of the body, and a second cutter for performing cutting at the first position in order to cut the welding tab to the predetermined length.

According to an embodiment of the present disclosure, when the first insertion line is stopped, the stack line may supply the double electrode assembly only to the second insertion line, and when the second insertion line is stopped, the stack line may supply the double electrode assembly only to the first insertion line.

According to an embodiment of the present disclosure, when one of the first processing line or the second processing line is stopped, the other one may operate to alternately manufacture the first-type electrode assembly and the second-type electrode assembly.

According to an embodiment of the present disclosure, when the second processing line is stopped, the first processing line may allow the first welder to alternately perform an operation of performing welding at the first position to manufacture the first-type electrode assembly and an operation of performing welding at a second position closer to the transfer table than the first position to manufacture the second-type electrode assembly and allow the first cutter to alternately perform an operation of performing cutting at the first position and an operation of performing cutting at the second position, and when the first processing line is stopped, the second processing line may allow the second welder to alternately perform an operation of performing welding at the first position to manufacture the second-type electrode assembly and an operation of performing welding at the second position closer to the transfer table than the first position to manufacture the first-type electrode assembly and allow the second cutter to alternately perform an operation of performing cutting at the first position and an operation of performing cutting at the second position.

According to an embodiment of the present disclosure, when the second processing line is stopped, the first processing line may alternately perform an operation of supplying the electrode assembly, seated on the first transfer table with the upper surface of the electrode assembly facing upward, to the first welder to manufacture the first-type electrode assembly and an operation of supplying the electrode assembly, seated on the first transfer table with the lower surface of the electrode assembly facing upward, to the first welder to manufacture the second-type electrode assembly, and when the first processing line is stopped, the second processing line may alternately perform an operation of supplying the electrode assembly, seated on the second transfer table with the lower surface of the electrode assembly facing upward, to the second welder to manufacture the second-type electrode assembly and an operating of supplying the electrode assembly, seated on the second transfer table with the upper surface of the electrode assembly facing upward, to the second welder to manufacture the first-type electrode assembly.

According to an embodiment of the present disclosure, when the second processing line is stopped, the first processing line may set the first transfer table on which the electrode assembly is seated with its upper surface facing upward and the first transfer table on which the electrode assembly is seated with its lower surface facing upward to have a stopping position different from each other in the first welder and the first cutter, and when the first processing line is stopped, the second processing line may set the second transfer table on which the electrode assembly is seated with its lower surface facing upward and the second transfer table on which the electrode assembly is seated with its upper surface facing upward to have a stopping position different from each other at the second welder and the second cutter.

According to an embodiment of the present disclosure, when the second processing line is stopped, the first processing line may supply the second-type electrode assembly upside down in the process of supplying the second-type electrode assembly to the stack line, and when the first processing line is stopped, the second processing line may supply the first-type electrode assembly upside down in the process of supplying the first-type electrode assembly to the stack line.

According to one aspect of the present disclosure, an operating method of a layout of a battery cell assembly apparatus comprises manufacturing a first-type electrode assembly by a first processing line, manufacturing a second-type electrode assembly by a second processing line arranged in parallel with the first processing line, manufacturing a double electrode assembly by a stack line by stacking and fixing the first-type electrode assembly and the second-type electrode assembly output from the first processing line and the second processing line, manufacturing a battery cell by a first insertion line by inserting the double electrode assembly into a case, and manufacturing a battery cell by a second insertion line arranged in parallel with the first insertion line by inserting the double electrode assembly into a case.

According to an embodiment of the present disclosure, processing speeds of manufacturing the first-type electrode assembly and manufacturing the second-type electrode assembly may be twice the processing speeds of manufacturing the battery cell by the first insertion line and manufacturing the battery cell by the second insertion line.

According to an embodiment of the present disclosure, the operating method of a layout of a battery cell assembly apparatus may further comprise inspecting the battery cell for a defect by a first inspection line arranged alongside the first insertion line, and inspecting the battery cell for a defect by a second inspection line arranged alongside the second insertion line and arranged in parallel with the first inspection line.

According to an embodiment of the present disclosure, manufacturing the first-type electrode assembly by the first processing line may comprise performing welding at a first position spaced apart from a first transfer table by a first distance to manufacture the first-type electrode assembly in a state in which an electrode assembly is seated on the first transfer table with an upper surface of the electrode assembly facing upward so that a welding tab is formed at a location closer to an upper surface than a lower surface of a body and performing cutting at the first position by a first cutter in order to cut the welding tab to a predetermined length, and manufacturing the second-type electrode assembly by the second processing line may comprise performing welding at the first position spaced apart from a second transfer table by the first distance to manufacture the second-type electrode assembly in a state in which the electrode assembly is seated on the second transfer table with a lower surface of the electrode assembly facing upward so that the welding tab is formed at a location closer to the lower surface than the upper surface of the body and performing cutting at the first position by a second cutter in order to cut the welding tab to a predetermined length.

According to an embodiment of the present disclosure, manufacturing the double electrode assembly may allow the stack line to supply the double electrode assembly only to the second insertion line when the first insertion line is stopped, and allow the stack line to supply the double electrode assembly only to the first insertion line when the second insertion line is stopped.

According to an embodiment of the present disclosure, when the second processing line is stopped, manufacturing the first-type electrode assembly by the first processing line may operate to alternately manufacture the first-type electrode assembly and the second-type electrode assembly, and when the first processing line is stopped, manufacturing the second-type electrode assembly by the second processing line may operate to alternately manufacture the second-type electrode assembly and the first-type electrode assembly.

According to an embodiment of the present disclosure, when the second processing line is stopped, performing welding by the first welder may allow the first welder to alternately perform an operation of performing welding at the first position to manufacture the first-type electrode assembly and an operation of performing welding at a second position closer to the transfer table than the first position to manufacture the second-type electrode assembly and performing cutting by the first cutter may allow the first cutter to alternately perform an operation of performing cutting at the first position and an operation of performing cutting at the second position, and when the first processing line is stopped, performing welding by the second welder may allow the second welder to alternately perform an operation of performing welding at the first position to manufacture the second-type electrode assembly and an operation of performing welding at the second position closer to the transfer table than the first position to manufacture the first-type electrode assembly and performing cutting by the second cutter may allow the second cutter to alternately perform an operation of performing cutting at the first position and an operation of performing cutting at the second position.

According to an embodiment of the present disclosure, when the second processing line is stopped, performing welding by the first welder may alternately perform an operation of supplying the electrode assembly, seated on the first transfer table with the upper surface of the electrode assembly facing upward, to the first welder to manufacture the first-type electrode assembly and an operation of supplying the electrode assembly, seated on the first transfer table with the lower surface of the electrode assembly facing upward, to the first welder to manufacture the second-type electrode assembly, and when the first processing line is stopped, performing welding by the second welder may alternately perform an operation of supplying the electrode assembly, seated on the second transfer table with the lower surface of the electrode assembly facing upward, to the second welder to manufacture the second-type electrode assembly and an operating of supplying the electrode assembly, seated on the second transfer table with the upper surface of the electrode assembly facing upward, to the second welder to manufacture the first-type electrode assembly.

According to an embodiment of the present disclosure, when the second processing line is stopped, manufacturing the first-type electrode assembly by the first processing line may set the first transfer table on which the electrode assembly is seated with the upper surface facing upward and the first transfer table on which the electrode assembly is seated with the lower surface facing upward to have a stopping position different from each other in the first welder and the first cutter, and when the first processing line is stopped, manufacturing the second-type electrode assembly by the second processing line may set the second transfer table on which the electrode assembly is seated with the lower surface facing upward and the second transfer table on which the electrode assembly is seated with the upper surface facing upward to have a stopping position different from each other at the second welder and the second cutter.

According to an embodiment of the present disclosure, when the second processing line is stopped, manufacturing the first-type electrode assembly by the first processing line may supply the second-type electrode assembly upside down in the process of supplying the second-type electrode assembly to the stack line, and when the first processing line is stopped, manufacturing the second-type electrode assembly by the second processing line may supply the first-type electrode assembly upside down in the process of supplying the first-type electrode assembly to the stack line.

Features and advantages of the present disclosure will become more apparent with the following detailed description based on the accompanying drawings.

Prior to this, terms or words used in the present specification and claims should not be interpreted in a conventional and dictionary sense, but should be interpreted as meaning and concept consistent with the technical idea of the present disclosure on the basis of the principle that an inventor may appropriately define the concept of terms in order to best describe the inventor’s invention.

According to an embodiment of the present disclosure, it is possible to minimize an area occupied by the layout of the battery cell assembly apparatus.

According to an embodiment of the present disclosure, even when any one assembly line is stopped in the layout of the battery cell assembly apparatus, the remaining assembly lines can continue to operate, thereby improving an operation efficiency.

### BRIEF DESCRIPTION OF THE DRAWINGS

FIG. 1 is a view schematically illustrating a layout of a battery cell assembly apparatus according to an embodiment.

FIG. 2 is a view illustrating a double electrode assembly formed by stacking a first-type electrode assembly and a second-type electrode assembly according to an embodiment.

FIG. 3 is a view illustrating a flow of an electrode assembly in a layout of a battery cell assembly apparatus according to an embodiment.

FIG. 4 is a view illustrating a first processing line, a second processing line, and a stack line in a layout of a battery cell assembly apparatus according to an embodiment.

FIG. 5 is a view illustrating a welding position of a welder in a state in which both a first processing line and a second processing line operate according to an embodiment.

FIG. 6 is a view illustrating a cutting position of a cutter in a state in which both a first processing line and a second processing line operate according to an embodiment.

FIG. 7 is a view illustrating an operation of an assembly apparatus in a state in which a second insertion line is stopped according to an embodiment.

FIG. 8 is a view illustrating an operation of an assembly apparatus in a state in which a second processing line is stopped according to an embodiment.

FIGS. 9 and 10 are views illustrating operations of a first processing line and a stack line in a state in which a second processing line is stopped according to an embodiment.

FIG. 11 is a view illustrating a difference in welding positions depending on a type of an electrode assembly when a single processing line manufactures both types of electrode assemblies.

FIG. 12 is a view illustrating a difference in cutting positions depending on a type of an electrode assembly when a single processing line manufactures both types of electrode assemblies.

FIGS. 13 and 14 are views illustrating a difference in a position of an electrode assembly supplied to a first processing line in a state in which a second processing line is stopped according to an embodiment.

FIG. 15 is a view illustrating a difference in a stopping position depending on a type of an electrode assembly of a first transfer table in a state in which a second processing line is stopped according to an embodiment.

FIG. 16 is a flowchart illustrating each step of an operating method of a layout of a battery cell

assembly apparatus according to an embodiment.

FIG. 17 is a flowchart illustrating each step of manufacturing a first-type electrode assembly by a first processing line and manufacturing a second-type electrode assembly by a second processing line according to an embodiment.

### DETAILED DESCRIPTION OF THE DISCLOSURE

Hereinafter, the present disclosure will be described in detail (with reference to the attached drawings). However, this may be only illustrative and the present disclosure may not be limited to the specific exemplary embodiments described as examples.

Hereinafter, an embodiment of the present disclosure will be described in detail with reference to the accompanying drawings.

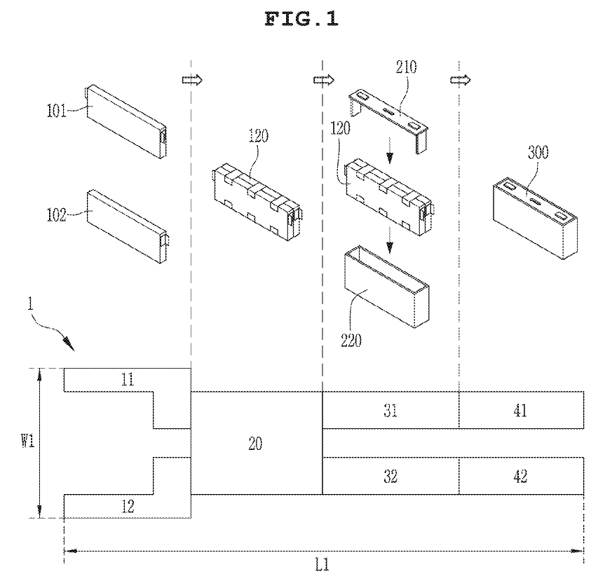

FIG. 1 is a view schematically illustrating a layout 1 of a battery cell 300 assembly apparatus according to an embodiment.

According to an embodiment, the layout 1 of the battery cell 300 assembly apparatus may comprise a first processing line 11 for manufacturing a first-type electrode assembly 101, a second processing line 12 for manufacturing a second-type electrode assembly 102, a stack line 20 for manufacturing a double electrode assembly 120 by stacking and fixing the first-type electrode assembly 101 and the second-type electrode assembly 102 output from the first processing line 11 and the second processing line 12, a first insertion line 31 for manufacturing a battery cell 300 by inserting the double electrode assembly 120 into a case, and a second insertion line 32 for manufacturing a battery cell 300 by inserting the double electrode assembly 120 into a case. Also, in order to reduce the length of the entire line, the first processing line 11 and the second processing line 12 may be arranged in parallel with each other, and the first insertion line 31 and the second insertion line 32 may be arranged in parallel with each other.

According to an embodiment, the layout 1 of the battery cell 300 assembly apparatus may further comprise a first inspection line 41 arranged alongside the first insertion line 31 for inspecting the battery cell 300 for a defect, and a second inspection line 42 arranged alongside the second insertion line 32 and arranged in parallel with the first inspection line 41 for inspecting the battery cell 300 for a defect.

The battery cell 300 assembly apparatus may comprise devices for performing detailed operations for assembling prismatic battery cells 300. The layout 1 of the battery cell 300 assembly apparatus may refer to a structure in which a plurality of devices for assembling the battery cell 300 is arranged as a first processing line 11, a second processing line 12, a stack line 20, a first insertion line 31, a second insertion line 32, a first inspection line 41, and a second inspection line 42.

The first processing line 11 and the second processing line 12 may be positioned in parallel to each other. The first processing line 11 and the second processing line 12 may comprise the same device. The first processing line 11 may manufacture a first-type electrode assembly 101, and the second processing line 12 may manufacture a second-type electrode assembly 102. The first-type electrode assembly 101 and the second-type electrode assembly 102 manufactured in the first processing line 11 and the second processing line 12 may be supplied to the stack line 20.

The stack line 20 may be connected to the first processing line 11 and the second processing line 12. The stack line 20 may comprise a device for stacking the first-type electrode assembly 101 and the second-type electrode assembly 102. The stack line 20 may comprise a device for stacking the first-type electrode assembly 101 and the second-type electrode assembly 102 and fixing the same by using a fixing film 110. A structure in which the first-type electrode assembly 101 and the second-type electrode assembly 102 are stacked and fixed may be referred to as a double electrode assembly 120. The stack line 20 may supply the double electrode assembly 120 to the first insertion line 31 and the second insertion line 32.

The first insertion line 31 and the second insertion line 32 may be connected to the stack line 20, respectively. The first insertion line 31 and the second insertion line 32 may comprise the same device. The first insertion line 31 and the second insertion line 32 may comprise a device for assembling the double electrode assembly 120 and a cell cap 210, a device for inserting the double electrode assembly 120, in which the cell cap 210 is assembled, into a can 220, a device for welding the can 220 and the cell cap 210, and the like. The first insertion line 31 and the second insertion line 32 may manufacture the same battery cell 300. The first insertion line 31 and the second insertion line 32 may be arranged in parallel. The battery cell 300 manufactured by the first insertion line 31 and the second insertion line 32 may be supplied to the first inspection line 41 and the second inspection line 42.

The first inspection line 41 and the second inspection line 42 may be connected in a line to the first insertion line 31 and the second insertion line 32, respectively. The first inspection line 41 and the second inspection line 42 may be arranged in parallel. The first inspection line 41 and the second inspection line 42 may comprise the same inspection device. The first inspection line 41 and the second inspection line 42 may comprise an X-ray inspection device, a CT (Computed Tomography), a leak inspection device, or the like. The first inspection line 41 and the second inspection line 42 may detect the battery cell 300 in which defects are present by inspecting the battery cell 300.

According to an embodiment, the layout 1 of the battery cell 300 assembly apparatus may comprise the parallel first processing line 11 and the second processing line 12, the stack line 20 connected to the first processing line 11 and the second processing line 12, the parallel first insertion line 31 and second insertion line 32 connected to the stack line 20, and the parallel first inspection line 41 and second inspection line 42 connected to the first insertion line 31 and the second insertion line 32.

In general, when a plurality of identical assembly apparatuses is arranged in a single assembly line, the production capacity of the battery cell 300 may be increased. For example, two welders, two cutters, two stackers, and two can 220 insertion devices may be arranged along a single assembly line.

However, when the plurality of assembly apparatuses is arranged in a line on a single assembly line, the length of the overall line may be increased.

Meanwhile, as in an embodiment, the length (L1) of the overall layout may be shortened by arranging the first processing line 11 and the second processing line 12 in parallel, arranging the first insertion line 31 and the second insertion line 32 in parallel, and arranging the first inspection line 41 and the second inspection line 42 in parallel. The length (L1) of the overall layout may be referred to as a length from the start point of the first processing line 11 to the end point of the first inspection line 41. The width (W1) of the layout may be referred to as a length between the first processing line 11 and the second processing line 12. The width (W1) of the layout may increase when the assembly lines are arranged in parallel. On the other hand, the length (L1) of the layout may decrease when the assembly lines are arranged in parallel. According to an embodiment, the layout of a structure in which the assembly lines are arranged in parallel may have a relatively large width compared to the layout in which the assembly lines are arranged in a line, but the length (L1) of the layout may be shortened, such that the reduced area of the layout is greater. Therefore, assembly equipment can be installed even when an area of a factory is small.

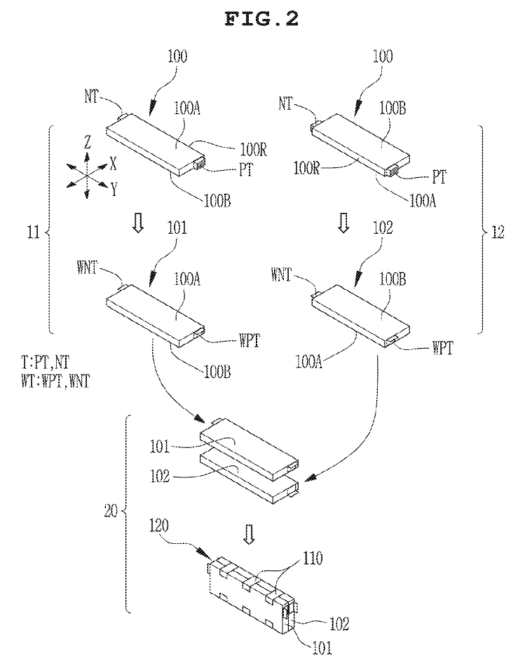

FIG. 2 is a view illustrating a double electrode assembly 120 formed by stacking a first-type electrode assembly 101 and a second-type electrode assembly 102 according to an embodiment. FIGS. 1 and 2 are referenced together.

The first-type electrode assembly 101 and the second-type electrode assembly 102 may comprise a body in which a positive electrode, a separator, and a negative electrode are laminated, and a welding tab (WT). The welding tab (WT) may comprise a welding negative tab (WNT) and a welding positive tab (WPT). A plurality of positive tabs (PT) connected to a plurality of positive electrodes may be welded to form the welding positive tab (WPT). A plurality of negative tabs (NT) connected to a plurality of negative electrodes may be welded to form the welding negative tab (WNT).

The first-type electrode assembly 101 may have the welding positive tab (WPT) positioned close to the upper surface 100A of the electrode assembly 100. The second-type electrode assembly 102 may have the welding positive tab (WPT) positioned close to the lower surface 100B of the electrode assembly 100. The first-type electrode assembly 101 and the second-type electrode assembly 102 may have the welding tab (WT) formed close to one side surface of the body. Specifically, when a vertical direction of the electrode assembly 100 is defined as the Z-axis and a direction (front-back direction) in which the positive tab (PT) and the negative tab (NT) are formed is defined as the Y-axis, the electrode tab (T) may be formed to be biased to one side in the X-axis. The electrode tabs (T) of the first-type electrode assembly 101 and the second-type electrode assembly 102 may be positioned close to the same side surface (for example, the right side 100R) in the X-axis. Also, the first-type electrode assembly 101 may have the welding tab (WT) formed close to an upper surface in the Z-axis and close to the right side 100R in the X-axis, and the second-type electrode assembly 102 may have the welding tab (WT) formed close to a lower surface in the Z-axis and close to the right side 100R in the X-axis.

The first processing line 11 may manufacture the first-type electrode assembly 101 by having a first welder 11A weld a plurality of electrode tabs (T) of the electrode assembly 100 at a position close to the upper surface along the Z-axis. Also, the second processing line 12 may manufacture the second-type electrode assembly 102 by having a second welder 12A weld a plurality of electrode tabs (T) of the electrode assembly 100 at a position close to the lower surface along the Z-axis. The first-type electrode assembly 101 and the second-type electrode assembly 102 may not have the same structure because the positions of the welding tab (WT) are different. In other words, the first-type electrode assembly 101 and the second-type electrode assembly 102 may not overlap each other even when any one of them is rotated.

The stack line 20 may stack the first-type electrode assembly 101 and the second-type electrode assembly 102 by arranging them parallel to each other in the Z-axis direction. The first-type electrode assembly 101 and the second-type electrode assembly 102 may be stacked such that the lower surface of the first-type electrode assembly 101 faces the upper surface of the second-type electrode assembly 102. Accordingly, the distance between the welding tab (WT) of the first-type electrode assembly 101 and the welding tab (WT) of the second-type electrode assembly 102 may be increased.

In the first insertion line 31 and the second insertion line 32, the cell cap 210 may be coupled in a direction in which the welding tab (WT) is formed close to the double electrode assembly 120. Specifically, when the welding tab (WT) is formed close to the right side 100R in the X-axis, the cell cap 210 may be coupled to the right side 100R of the double electrode assembly 120. Also, it may be inserted into the can 220 from the left side of the double electrode assembly 120.

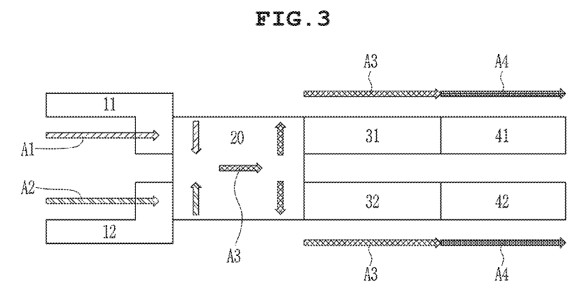

FIG. 3 is a view illustrating a flow of an electrode assembly 100 in a layout 1 of a battery cell 300 assembly apparatus according to an embodiment. FIGS. 1, 2, and 3 are referenced together. In FIG. 3, an arrow A1 may represent a path along which the first-type electrode assembly 101 moves, an arrow A2 may represent a path along which the second-type electrode assembly 102 moves, an arrow A3 may represent a path along which the double electrode assembly 120 moves, and an arrow A4 may represent a path along which the battery cell 300 moves.

A plurality of devices comprised in the layout 1 of the battery cell 300 assembly apparatus may perform different operations and therefore may have different operation times. The first processing line 11 and the second processing line 12 may have relatively short operation times, and the first insertion line 31 and the second insertion line 32 may have relatively long operation times. Since the first-type electrode assembly 101 and the second-type electrode assembly 102 are stacked to assemble the double electrode assembly 120, the first processing line 11, the second insertion line 32, and the stack line 20 may have the same operation time. Since the operation times of the first insertion line 31 and the second insertion line 32 are relatively long, the stack line 20 may distribute the double electrode assembly 120 to the first insertion line 31 and the second insertion line 32. Since the operation times of the first insertion line 31 and the second insertion line 32 are long, the bottleneck phenomenon may be minimized by arranging the first insertion line 31 and the second insertion line 32 in parallel.

According to an embodiment, the processing speeds of the first processing line 11 and the second processing line 12 may be twice the processing speeds of the first insertion line 31 and the second insertion line 32. For example, the first processing line 11 may manufacture 18 first-type electrode assemblies 101 per minute, and the second processing line 12 may manufacture 18 first-type electrode assemblies 101 per minute. Also, the stack line 20 may assemble 18 double electrode assemblies 120 per minute. Also, the first insertion line 31 and the first inspection line 41 may manufacture and inspect 9 battery cells 300 per minute, and the second insertion line 32 and the second inspection line 42 may manufacture and inspect 9 battery cells 300 per minute. Finally, the layout 1 of the battery cell 300 assembly apparatus may assemble 18 battery cells 300 per minute.

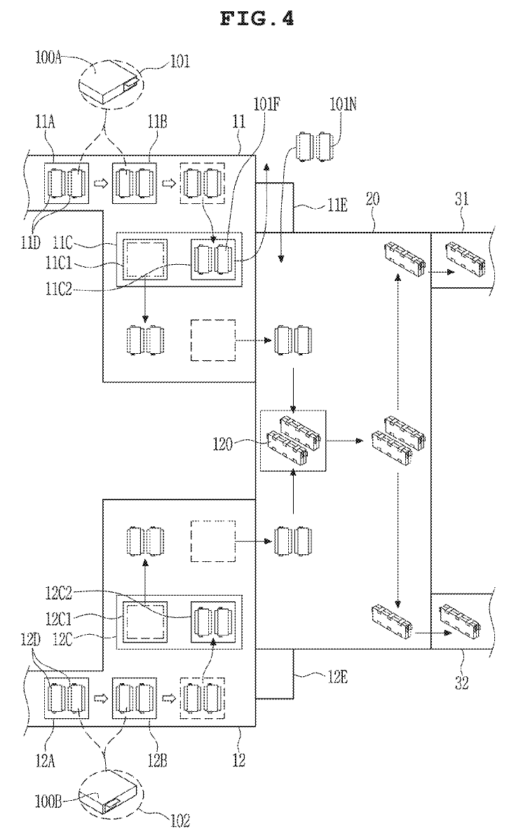

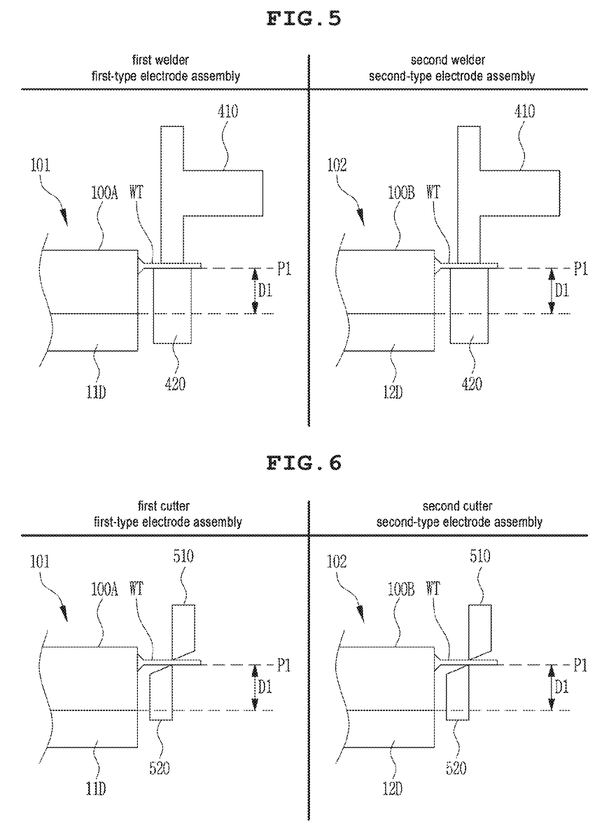

FIG. 4 is a view illustrating a first processing line 11, a second processing line 12, and a stack line 20 in a layout 1 of a battery cell 300 assembly apparatus according to an embodiment. FIG. 5 is a view illustrating a welding position of a welder in a state in which both a first processing line 11 and a second processing line 12 operate according to an embodiment. FIG. 6 is a view illustrating a cutting position of a cutter in a state in which both a first processing line 11 and a second processing line 12 operate according to an embodiment. FIGS. 1 through 6 are referenced together.

According to an embodiment, the first processing line 11 may comprise a first welder 11A for performing welding at a first position (P1) spaced apart from a first transfer table 11D by a first distance (D1) to manufacture the first-type electrode assembly 101 in a state in which the electrode assembly 100 is seated on the first transfer table 11D with the upper surface 100A of the electrode assembly 100 facing upward so that the welding tab (WT) is formed at a location closer to the upper surface than the lower surface of the body, and a first cutter 11B for performing cutting at the first position (P1) in order to cut the welding tab (WT) to a predetermined length. The first processing line 11 may further comprise a first inspector 11C for inspecting the state of the first-type electrode assembly 101. The first processing line 11 may further comprise a first exchanger 11E for discharging a defective first-type electrode assembly 101 to the outside and supplying a normal first-type electrode assembly 101 to the stack line 20. The first processing line 11 may further comprise the first transfer table 11D for transferring the electrode assembly 100.

The second processing line 12 may comprise a second welder 12A for performing welding at a first position (P1) spaced apart from the second transfer table 12D by a first distance (D1) to manufacture the second-type electrode assembly 102 in a state in which the electrode assembly 100 is seated on the second transfer table 12D with the lower surface 100B of the electrode assembly 100 facing upward so that the welding tab (WT) is formed at a location closer to the lower surface than the upper surface of the body, and a second cutter 12B for performing cutting at the first position (P1) in order to cut the welding tab (WT) to a predetermined length. The second processing line 12 may further comprise a second inspector 12C for inspecting the state of the second-type electrode assembly 102. The second processing line 12 may further comprise a second exchanger 12E for discharging a defective second-type electrode assembly 102 to the outside and supplying a normal second-type electrode assembly 102 to the stack line 20. The second processing line 12 may further comprise a second transfer table 12D for transferring the electrode assembly 100.

The first welder 11A and the second welder 12A may weld the plurality of positive tabs (PT) of the electrode assembly 100 to form the welding tab (WT). The first welder 11A and the second welder 12A may comprise a laser welder, an ultrasonic welder, or the like. In an ultrasonic welder, a plurality of electrode tabs (T) may be positioned between a horn 410 and an anvil 420, and the horn 410 may vibrate to weld the plurality of electrode tabs (T).

The first welder 11A and the second welder 12A may allow the positions of the horn 410 and the anvil 420 to be movable so that the welding tab (WT) is formed at a predetermined position. The welding positions of the first welder 11A and the second welder 12A may be set such that the welding tab (WT) of the first-type electrode assembly 101 is formed close to the upper surface 100A of the electrode assembly 100, and the welding tab (WT) of the second-type electrode assembly 102 is formed close to the lower surface 100B of the electrode assembly 100.

The first cutter 11B and the second cutter 12B may cut an edge of the welding tab (WT). The first cutter 11B and the second cutter 12B may cut the welding tab (WT) by using an upper blade 510 and a lower blade 520. The welding tab (WT) may be positioned between the upper blade 510 and the lower blade 520, and the upper blade 510 and the lower blade 520 may move toward each other to cut the welding tab (WT).

The first processing line 11 may position the electrode assembly 100 on the first transfer table 11D and then perform welding and cutting while passing through the first welder 11A and the first cutter 11B. The second processing line 12 may position the electrode assembly 100 on the second transfer table 12D and then perform welding and cutting while passing through the second welder 12A and the second cutter 12B. The first transfer table 11D and the second transfer table 12D may be implemented using a conveyor belt, a linear motion system (LMS), or the like.

In the first processing line 11, the electrode assembly 100 may undergo welding, cutting, and inspection. In the second processing line 12, the electrode assembly 100 may undergo welding, cutting, and inspection. The first inspector 11C of the first processing line 11 and the second inspector 12C of the second processing line 12 may inspect whether defects are present in the first-type electrode assembly 101 and the second-type electrode assembly 102. The first inspector 11C and the second inspector 12C may perform various inspections such as vision inspections using cameras and image analysis, inspections using X-rays, and the like. The operation times for the first inspector 11C and the second inspector 12C to perform inspections may be relatively long. In order to prevent a bottleneck phenomenon in the first inspector 11C and the second inspector 12C, the first inspector 11C and the second inspector 12C may each comprise a plurality of inspection tables. For example, the first inspector 11C may comprise two inspection tables, and the second inspector 12C may comprise two inspection tables. While the first-type electrode assembly 101 is first input to any one of the two inspection tables of the first inspector 11C to perform the inspection, the first-type electrode assembly 101 may be input to the other one of the two inspection tables to perform the inspection. The first inspector 11C may discharge the first-type electrode assembly 101 after completing the inspection, and the first-type electrode assembly 101 determined to be normal may be supplied to the stack line 20. The second inspector 12C may have a similar structure.

When a defect exists as a result of the inspection, the first exchanger 11E may discharge the first-type electrode assembly 101F, in which the defect exists, to the outside, and may supply the normal first-type electrode assembly 101N to the stack line 20. When a defect exists as a result of the inspection, the second exchanger 12E may discharge the second-type electrode assembly 102, in which the defect exists, to the outside, and may supply the normal second-type electrode assembly 102 to the stack line 20.

The first processing line 11 and the second processing line 12 may be configured such that the plurality of electrode assemblies 100 moves for each pitch. The pitch may refer to a time interval at which a workpiece moves between a plurality of devices comprised in the assembly line. For example, the first processing line 11 and the second processing line 12 may be configured such that the two electrode assemblies 100 move for one pitch. Specifically, the two electrode assemblies 100 may be simultaneously welded in the welder, and then the two electrode assemblies 100 may be configured to move to the cutter at the same time. In this case, the first processing line 11 may comprise two first welders 11A arranged in a line and two first cutters 11B arranged in a line. Similar to the first processing line 11, the second processing line 12 may comprise two second welders 12A and two second cutters 12B.

The first inspector 11C and the second inspector 12C may inspect a plurality of electrode assemblies 100 in which one inspection table moves for one pitch. The first inspector 11C and the second inspector 12C may comprise two inspection tables, and the plurality of electrode assemblies 100 that move for one pitch may be inspected at each inspection table. For example, two first-type electrode assemblies 101 moving for one pitch may be input to one side of the inspection table of the first inspector 11C to perform inspection, and when one pitch is further performed, two first-type electrode assemblies 101 may be input to the other side of the inspection table of the first inspector 11C to perform inspection. The second inspector 12C may also operate in a manner similar to the first inspector 11C.

The first exchanger 11E and the second exchanger 12E may exchange the plurality of first-type electrode assemblies 101 or the plurality of second-type electrode assemblies 102 that moves per pitch. The first exchanger 11E and the second exchanger 12E may comprise one or more pick-up and place devices and the like. For example, when two electrode assemblies 100 are configured to move for each pitch, the first exchanger 11E may discharge all of the two first-type electrode assemblies 101 even when only one of the two first-type electrode assemblies 101 comprised in one pitch has a defect, and may supply the two normal first-type electrode assemblies 101 to the stack line 20. Similar to the first exchanger 11E, the second exchanger 12E may exchange two second-type electrode assemblies 102 for one pitch. By discharging defective electrode assemblies 100 and supplying normal electrode assemblies 100 in pitch units, the exchange operation time can be minimized.

The stack line 20 may receive two first-type electrode assemblies 101 and two second-type electrode assemblies 102 as input for one pitch, and may assemble the two double electrode assemblies 120. The stack line 20 may supply one of the two double electrode assemblies 120 assembled for one pitch to the first insertion line 31, and supply the other one to the second insertion line 32.

FIGS. 5 and 6 are referenced together. The first welder 11A may perform welding at the first position (P1) located at the first distance (D1) from the first transfer table 11D in order to form the welding tab (WT) at a position close to the upper surface 100A of the electrode assembly 100. In this case, the electrode assembly 100 may be seated on the first transfer table 11D with the upper surface facing upward. The first position (P1) may be a position close to the upper surface 100A of the electrode assembly 100 seated on the first transfer table 11D.

The second welder 12A may perform welding at the first position (P1) located at the first distance (D1) from the second transfer table 12D in order to form the welding tab (WT) at a position close to the lower surface 100B of the electrode assembly 100. In this case, the electrode assembly 100 may be seated on the first transfer table 11D with the lower surface facing upward. The first position (P1) may be a position close to the lower surface 100B of the electrode assembly 100 seated on the second transfer table 12D.

The first position (P1) of the first welder 11A and the second welder 12A may be located at the same first distance (D1) from the transfer table. However, the electrode assembly 100 seated on the first transfer table 11D may have the upper surface facing upward, and the electrode assembly 100 seated on the second transfer table 12D may have the lower surface facing upward. Since there is a difference in the direction of the electrode assembly 100, the welding tab (WT) may be formed close to the upper surface or the lower surface even when the first welder 11A and the second welder 12A perform welding at the same first position (P1).

Similarly, the first cutter 11B and the second cutter 12B may perform cutting at the same first position (P1). It is necessary to perform cutting at the position where the welding tab (WT) is formed. Accordingly, since the first-type electrode assembly 101 seated on the first transfer table 11D has the welding tab (WT) formed at the first position (P1), the first cutter 11B may also perform cutting at the first position (P1). Also, since the second-type electrode assembly 102 seated on the second transfer table 12D has the welding tab (WT) formed at the first position (P1), the second cutter 12B may also perform cutting at the first position (P1).

The welding tab (WT) may leave different marks on the surface where the horn 410 comes into contact and the surface where the anvil 420 comes into contact. A trace of the horn 410 vibrating may remain on the surface where the horn 410 comes into contact in the welding tab (WT). The welding tab (WT) of the first-type electrode assembly 101 may leave a trace of the horn 410 coming into contact on the surface in the direction of the upper surface 100A of the electrode assembly 100. The welding tab (WT) of the second-type electrode assembly 102 may leave a trace of the horn 410 coming into contact on the surface in the direction of the lower surface 100B of the electrode assembly 100. Therefore, the two facing welding tabs (WT) in the double electrode assembly 120 may remain in a state where traces of the horn 410 coming into contact are on the outer surface thereof.

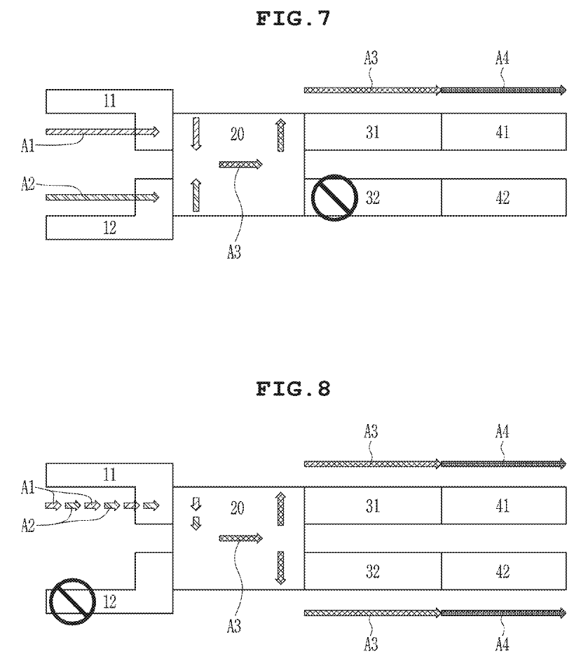

FIG. 7 is a view illustrating an operation of an assembly apparatus in a state in which a second insertion line 32 is stopped according to an embodiment. In FIG. 7, an arrow A1 may represent a path along which the first-type electrode assembly 101 moves, an arrow A2 may represent a path along which the second-type electrode assembly 102 moves, an arrow A3 may represent a path along which the double electrode assembly 120 moves, and an arrow A4 may represent a path along which the battery cell 300 moves.

The first processing line 11, the second processing line 12, the first insertion line 31, or the second insertion line 32 may be temporarily stopped for various reasons. For example, causes of stopping may comprise inspection of the assembly apparatus, supply of materials or components, failure, and the like. When inspection is required, stopping the entire battery cell 300 assembly apparatus may significantly reduce the operation rate. When the processing line, the stack line 20, the insertion line, and the inspection line are arranged in a line, the stopping in any one of the lines may require the entire system to stop, thereby resulting in a considerable drop in operation rate.

According to an embodiment, even when any one of the first processing line 11 and the second processing line 12 arranged parallel to each other is stopped, or even when any one of the first insertion line 31 and the second insertion line 32 is stopped, the remaining ones can operate to manufacture the battery cell 300. Accordingly, the operation rate of the battery cell 300 assembly apparatus may be improved.

First, when either the first insertion line 31 or the second insertion line 32 is stopped, a method in which the remaining lines operate will be described. According to an embodiment, when the first insertion line 31 is stopped, the stack line 20 may supply the double electrode assembly 120 only to the second insertion line 32. And, when the second insertion line 32 is stopped, the stack line 20 may supply the double electrode assembly 120 only to the first insertion line 31.

When the second insertion line 32 is in a stopped state, the first insertion line 31 may operate normally. Also, when the first insertion line 31 is in a stopped state, the second insertion line 32 may operate normally. The stack line 20 may supply the double electrode assembly 120 only to the first insertion line 31 or the second insertion line 32 that operates normally.

In a state in which only one of the first insertion line 31 or the second insertion line 32 operates, the stack line 20 may operate slowly. For example, when only the first insertion line 31 operates, the processing capacity of the first insertion line 31 may be 9 battery cells 300 per minute. In this case, the stack line 20 may also slow down its processing speed to assemble 9 double electrode assemblies 120 per minute. Also, the first processing line 11 may slow down its processing speed to manufacture 9 first-type electrode assemblies 101 per minute, and the second processing line 12 may also slow down its processing speed to manufacture 9 first-type electrode assemblies 101 per minute. Controlling the processing speeds of the first processing line 11, the second processing line 12, and the stack line 20 may be performed in a process management system. Alternatively, the first processing line 11, the second processing line 12, and the stack line 20 may be controlled to sequentially slow the processing speed by using an algorithm that does not transfer a workpiece to the next facility when a workpiece is already present in the next facility.

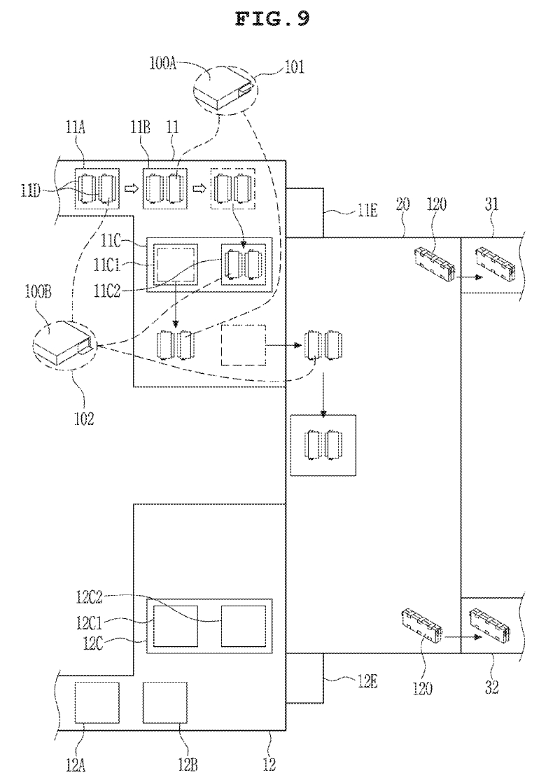

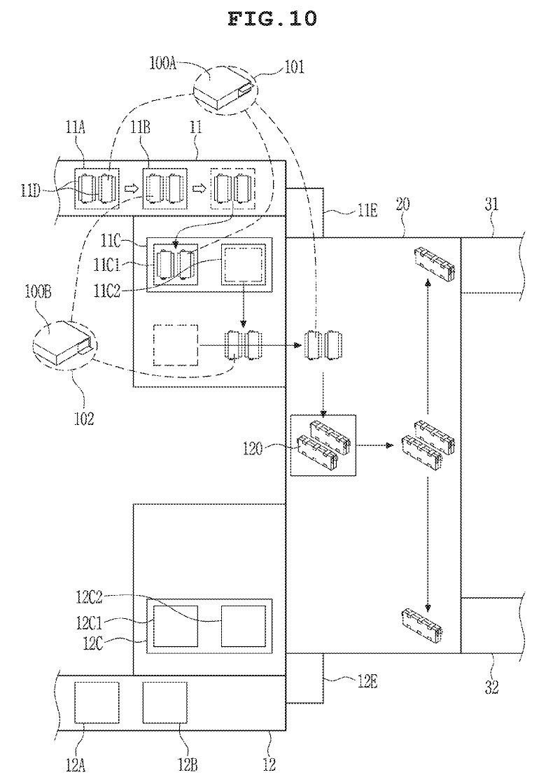

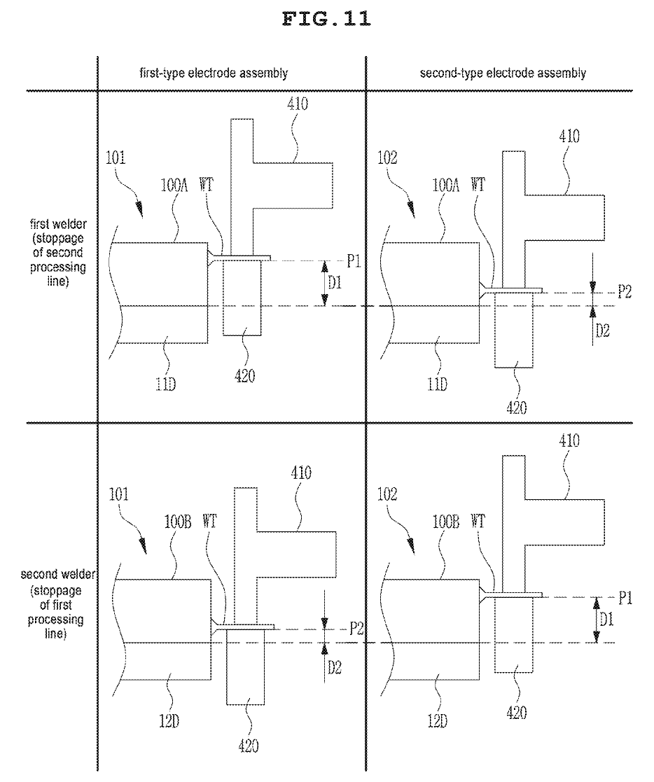

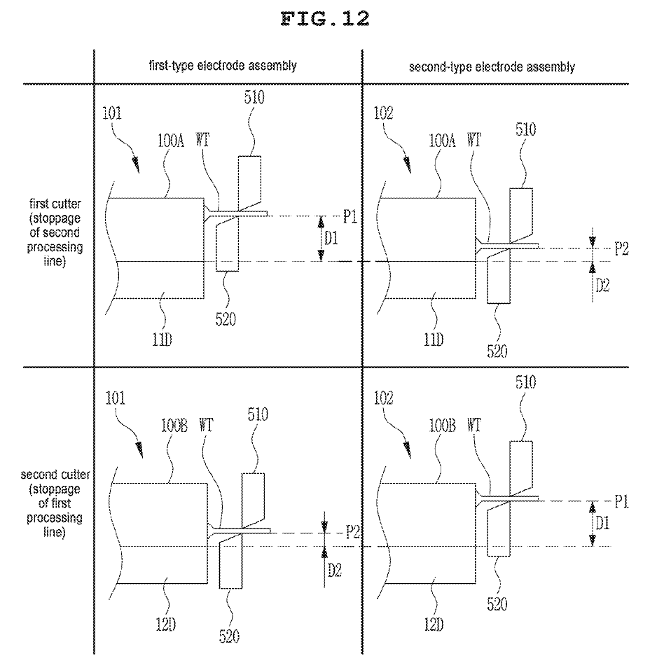

FIG. 8 is a view illustrating an operation of an assembly apparatus in a state in which a second processing line 12 is stopped according to an embodiment. FIGS. 9 and 10 are views illustrating operations of a first processing line 11 and a stack line 20 in a state in which a second processing line 12 is stopped according to an embodiment. FIG. 11 is a view illustrating a difference in welding positions depending on a type of an electrode assembly 100 when a single processing line manufactures both types of electrode assemblies 100. FIG. 12 is a view illustrating a difference in cutting positions depending on a type of an electrode assembly 100 when a single processing line manufactures both types of electrode assemblies 100.

As illustrated in FIG. 8, when either the first processing line 11 or the second processing line 12 is stopped, the other one may need to produce both the first-type electrode assembly 101 and the second-type electrode assembly 102. According to an embodiment, when one of the first processing line 11 or the second processing line 12 is stopped, the other one may operate to alternately manufacture the first-type electrode assembly 101 and the second-type electrode assembly 102. When the first-type electrode assembly 101 and the second-type electrode assembly 102 are alternately supplied to the stack line 20, the double electrode assembly 120 may be assembled in the stacking line 20.

When the second processing line 12 is stopped, the operation of the first processing line 11 will be described with reference to FIGS. 9 and 10. FIGS. 9 and 10 illustrate the operation in which the first processing line 11 alternately manufactures the first-type electrode assembly 101 and the second-type electrode assembly 102. FIGS. 9 and 10 illustrate a structure in which two electrode assemblies 100 move to a next process simultaneously for one pitch. FIG. 9 illustrates a state in which the welding tab (WT) of the second-type electrode assembly 102 is formed by the first welder 11A and the welding tab (WT) of the first-type electrode assembly 101 is cut by the first cutter 11B. FIG. 10 illustrates a state in which the welding tab (WT) of the first-type electrode assembly 101 is formed by the first welder 11A and the welding tab (WT) of the second-type electrode assembly 102 is cut by the first cutter 11B.

When the second processing line 12 is stopped, the first processing line 11 may be configured such that the first welder 11A alternately performs an operation of performing welding at the first position (P1) to manufacture the first-type electrode assembly 101 and an operation of performing welding at the second position (P2) closer to the transfer table than the first position (P1) to manufacture the second-type electrode assembly 102, and the first cutter 11B alternately performs an operation of performing cutting at the first position (P1) and an operation of performing cutting at the second position (P2).

As described with reference to FIG. 2, the first-type electrode assembly 101 and the second-type electrode assembly 102 may not have the same structure. Accordingly, in order to manufacture the second-type electrode assembly 102 in the first processing line 11, changes for the first processing line 11 to manufacture the second-type electrode assembly 102 may be required. Unlike described with reference to FIGS. 5 and 6, the first welder 11A may alternately perform an operation of performing welding at the first position (P1) and an operation of performing welding at the second position (P2), and the first cutter 11B may alternately perform an operation of performing cutting at the first position (P1) and an operation of performing cutting at the second position (P2).

In FIG. 11, the first welder 11A may perform welding at the first position (P1) spaced apart from the first transfer table 11D by the first distance (D1) in order to form the welding tab (WT) of the first-type electrode assembly 101. Also, the first welder 11A may perform welding at the second position (P2) spaced apart from the first transfer table 11D by the second distance (D2) in order to form the welding tab (WT) of the second-type electrode assembly 102. Since the electrode assembly 100 seated on the first transfer table 11D in the first processing line 11 has its upper surface facing upward, a change in a welding position may be required to manufacture the second-type electrode assembly 102. Accordingly, the second position (P2) may be a location spaced apart from the first transfer table 11D by the second distance (D2) smaller than the first distance (D1), and may be determined as a location closer to the lower surface 100B of the electrode assembly 100. The first position (P1) may be farther away from the first transfer table 11D than the second position (P2). The first distance (D1) may be greater than the second distance (D2). The first position (P1) may be a position closer to the upper surface than the lower surface 100B of the electrode assembly 100, and the second position (P2) may be a position closer to the lower surface than the upper surface 100A of the electrode assembly 100.

When both the first-type electrode assembly 101 and the second-type electrode assembly 102 are manufactured in the first processing line 11, the positions of the traces left on the welding tab (WT) may be different. The welding tab (WT) of the first-type electrode assembly 101 may leave a trace of the horn 410 coming into contact on the surface in the direction of the upper surface 100A of the electrode assembly 100. The welding tab (WT) of the second-type electrode assembly 102 may leave a trace of the horn 410 coming into contact on the surface in the direction of the upper surface 100A of the electrode assembly 100. In this case, only one of the outer surfaces of a pair of welding tabs (WT) facing each other in the double electrode assembly 120 may have a trace of the horn 410 coming into contact.

In FIG. 12, the first cutter 11B may perform welding at the first position (P1) spaced apart from the first transfer table 11D by the first distance (D1) in order to cut the welding tab (WT) of the first-type electrode assembly 101. Also, the first cutter 11B may perform welding at the second position (P2) spaced apart from the first transfer table 11D by the second distance (D2) in order to cut the welding tab (WT) of the second-type electrode assembly 102. In order to cut the welding tab (WT), it is necessary to perform cutting at a position where the welding tab (WT) is formed. Therefore, the first cutter 11B may also perform cutting at the same position as the position where the first welder performs welding.

The horn 410 and the anvil 420 of the first welder 11A may be moved up and down together or separately. The first welder 11A may move the horn 410 and the anvil 420 up and down by using mechanical elements such as a motor, a gear, a frame, a cylinder, and the like. The upper blade 510 and the lower blade 520 of the first cutter 11B may be moved up and down together or separately. The first cutter 11B may move the horn 410 and the anvil 420 up and down by using mechanical elements such as a motor, a gear, a frame, a cylinder, and the like. When the second process line is stopped, the first welder 11A and the first cutter 11B may perform predetermined operations at the first position (P1) and the second position (P2) according to the control of the process control system in order to alternately manufacture the first-type electrode assembly 101 and the second-type electrode assembly 102.

The first inspector 11C may inspect the first-type electrode assembly 101 in one of the two inspection tables and inspect the second-type electrode assembly 102 in the other one. The first exchanger 11E may discharge the defective first-type electrode assembly 101 and supply the normal first-type electrode assembly 101 to the stack line 20, and discharge the defective second-type electrode assembly 102 and supply the normal second-type electrode assembly 102 to the stack line 20.

When the first processing line 11 is stopped, the second processing line 12 may operate in a manner similar to that described with reference to FIGS. 9, 10, 11, and 12.

When the first processing line 11 is stopped, the second processing line 12A may be configured such that the second welder (12A) alternately performs an operation of performing welding at the first position (P1) to manufacture the second-type electrode assembly 102 and an operation of performing welding at the second position (P2) closer to the transfer table than the first position (P1) to manufacture the first-type electrode assembly 101, and the second cutter 12B alternately performs an operation of performing cutting at the first position (P1) and an operation of performing cutting at the second position (P2).

FIG. 11 is referred. The electrode assembly 100 may be seated on the second transfer table 12D of the second processing line 12 with the lower surface 100B facing upward. Accordingly, when the second welder 12A performs welding at the first position (P1), the welding tab (WT) may be formed at a position close to the lower surface 100B of the electrode assembly 100, and the second-type electrode assembly 102 may be manufactured. In order to manufacture the first-type electrode assembly 101, the second welder 12A may perform welding at the second position (P2) spaced apart from the second transfer table 12D by the second distance (D2). When the second welder 12A performs welding at the second position (P2), the welding tab (WT) may be formed at a position close to the upper surface 100A of the electrode assembly 100, and the first-type electrode assembly 101 may be manufactured. The first position (P1) may be a position closer to the lower surface than the upper surface 100A of the electrode assembly 100, and the second position (P2) may be a position closer to the upper surface than the lower surface 100B of the electrode assembly 100.

FIG. 12 is referenced. Since the cutting is performed at the position of the welding tab (WT), the second cutter 12B may alternately perform cutting at the first position (P1) and the second position (P2). The second cutter 12B may cut the welding tab (WT) of the second-type electrode assembly 102 at the first position (P1), and the second cutter 12B may cut the welding tab (WT) of the first-type electrode assembly 101 at the second position (P2).

A method of manufacturing two types of electrode assemblies 100 in the first processing line 11 or the second processing line 12 in a way of changing the operation positions of a welder and a cutter may have been described with reference to FIGS. 8 to 12. The method of changing the operation positions of a welder and a cutter may require that the welder and the cutter have a structure allowing to change the operation positions, may take time to alternately change the operation positions, and may require to confirm whether to operate at the correct position.

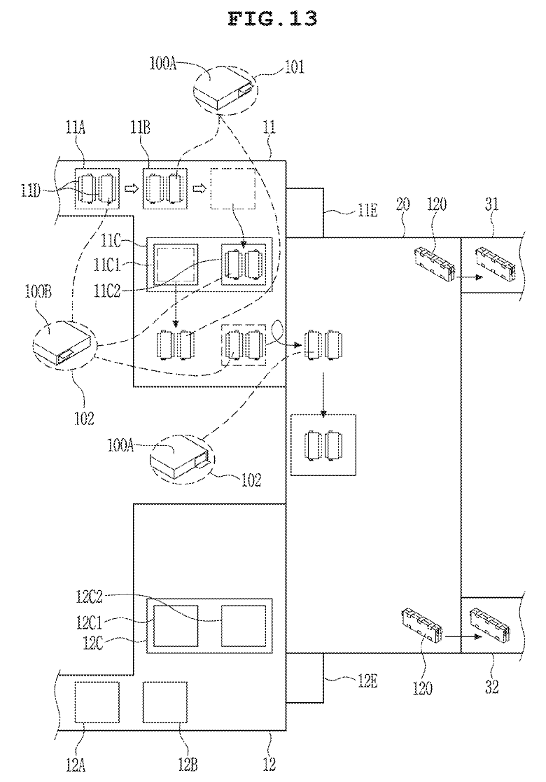

Referring to FIGS. 13 to 15, a method may be described that manufactures two types of electrode assemblies 100 in the first processing line 11 or the second processing line 12 without changing the operation positions of the welder and cutter.

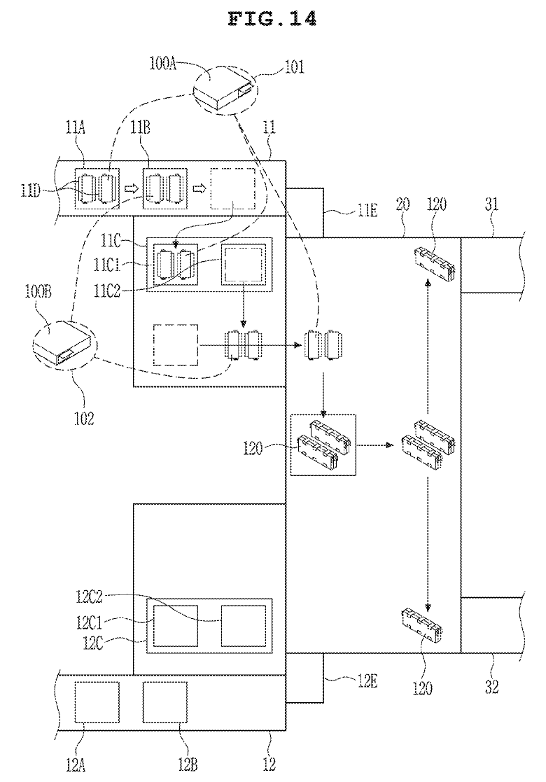

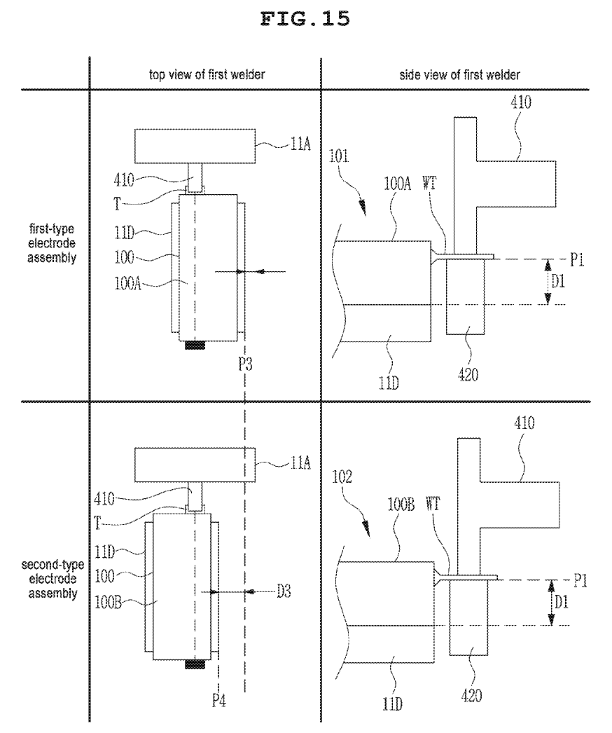

FIGS. 13 and 14 are views illustrating a difference in a position of an electrode assembly 100 supplied to a first processing line 11 in a state in which a second processing line 12 is stopped according to an embodiment. FIG. 15 is a view illustrating a difference in a stopping position according to a type of an electrode assembly 100 of a first transfer table 11D in a state in which a second processing line 12 is stopped according to an embodiment.

According to an embodiment, when the second processing line 12 is stopped, the first processing line 11 may alternately perform an operation of supplying the electrode assembly 100, seated on the first transfer table 11D with the upper surface 100A of the electrode assembly 100 facing upward, to the first welder 11A to manufacture the first-type electrode assembly 101, and an operation of supplying the electrode assembly 100, seated on the first transfer table 11D with the lower surface 100B of the electrode assembly 100 facing upward, to the first welder 11A to manufacture the second-type electrode assembly 102.

As illustrated in FIGS. 13 and 14, the electrode assembly 100 seated on the first transfer table 11D of the first processing line 11 may be alternately seated with the upper surface facing upward or downward. As illustrated in FIG. 15, the electrode assembly 100 seated on the first transfer table 11D with its upper surface facing upward may have the welding tab (WT) formed at the first position (P1) by the first welder 11A to become the first-type electrode assembly 101. The electrode assembly 100 seated on the first transfer table 11D with its lower surface facing upward may have the welding tab (WT) formed at the first position (P1) by the first welder 11A to become the second-type electrode assembly 102.

The first welder 11A may alternately manufacture the first-type electrode assembly 101 and the second-type electrode assembly 102, but the welding position may be the same as the first position (P1) because the direction of the electrode assembly 100 seated on the first transfer table 11D is alternately changed. The first cutter 11B for cutting the welding tab (WT) of the first-type electrode assembly 101 and the second-type electrode assembly 102 may also perform cutting at the same first position (P1).

When the first welder 11A performs welding at the first position (P1), a trace of the horn 410 coming into contact may remain on the surface in the direction of the upper surface 100A of the electrode assembly 100 of the welding tab (WT) of the first-type electrode assembly 101. Also, when the first welder 11A performs welding at the first position (P1), a trace of the horn 410 coming into contact may remain on the surface in the direction of the lower surface 100B of the electrode assembly 100 of the welding tab (WT) of the second-type electrode assembly 102. Accordingly, the two welding tabs (WT) that face each other in the double electrode assembly 120 may leave a trace of the horn 410 coming into contact on the outer surfaces.

The position of the welding tab (WT) may be recognized using a vision camera or the like in the first insertion line 31 or the second insertion line 32. A trace of the horn 410 coming into contact located on the welding tab (WT) may affect optimization for recognizing the welding tab (WT). In a state in which all lines operate normally, the first insertion line 31 or the second insertion line 32 may be optimized on the basis of a state in which a trace of the horn 410 coming into contact is present on the outer surface of the welding tab (WT) of the double electrode assembly 120.

As described with reference to FIGS. 8 to 12, in a case that the trace of the horn 410 coming into contact is present only on one of the outer surfaces of the welding tab (WT) of the double electrode assembly 120 when the second processing line 12 is stopped, it may affect the optimization of the first insertion line 31 or the second insertion line 32. On the other hand, in a case that the trace of the horn 410 coming into contact is present only on the outer surfaces of the welding tab (WT) of the double electrode assembly 120 when the second processing line 12 is stopped, the optimization of the first insertion line 31 or the second insertion line 32 may be applied as it is. Accordingly, the optimization of the first insertion line 31 or the second insertion line 32 that is the same as when all lines are operating normally may be used, thereby reducing the defect rate in the manufacturing process.

When the second processing line 12 is stopped, the first processing line 11 may be configured such that the first transfer table 11D in which the electrode assembly 100 is seated with its upper surface facing upward and the first transfer table 11D in which the electrode assembly 100 is seated with its lower surface facing upward have a stopping position different from each other in the first welder 11A and the first cutter 11B.

As described with reference to FIG. 2, the welding tabs (WT) of the first-type electrode assembly 101 and the second-type electrode assembly 102 may be formed at a position close to one side (for example, the right side 100R) in the X-axis direction. In this case, the position of the welding tab (WT) may differ depending on the case when the electrode assembly 100 is seated on the first transfer table 11D with its upper surface 100A facing upward and on the case when the electrode assembly 100 is seated on the first transfer table 11D with its lower surface 100B facing upward. When the electrode assembly 100 is seated on the first transfer table 11D with its upper surface facing upward, the first transfer table 11D may need to stop at the third position (P3) in order to position a plurality of electrode tabs (T) between the horn 410 and the anvil 420 of the first welder 11A. Also, when the electrode assembly 100 is seated on the first transfer table 11D with its upper surface facing downward, the first transfer table 11D may need to stop at the fourth position (P4) in order to position the plurality of electrode tabs (T) between the horn 410 and the anvil 420 of the first welder (11A).

The position at which the first transfer table 11D stops may be precisely controlled. The first transfer table 11D may be configured with a linear motion system or the like, and may be stopped at a desired position so that the electrode tab (T) of the electrode assembly 100 is positioned between the horn 410 and the anvil 420 of the welder. Also, the first transfer table 11D may be stopped at a desired position such that the welding tab (WT) is positioned between the upper blade 510 and the lower blade 520 of the cutter.

When the second processing line 12 is stopped, the first processing line 11 may supply the second-type electrode assembly 102 upside down in the process of supplying the second-type electrode assembly 102 to the stack line 20.

In the first processing line 11, the electrode assembly 100 may be seated on the first transfer table 11D with its upper surface facing upward. Accordingly, the first-type electrode assembly 101 manufactured in the first processing line 11 may be supplied to the stack line 20 as it is. On the other hand, the second-type electrode assembly 102 manufactured in the first processing line 11 while being seated on the first transfer table 11D with its lower surface 100B facing upward in a state in which the second processing line 12 is stopped may be supplied upside down in order to be supplied to the stack line 20. The second-type electrode assembly 102 passing through the first processing line 11 in a state in which the lower surface 100B faces upward may be supplied to the stack line 20 upside down so that the upper surface 100A faces upward. The operation of flipping the second-type electrode assembly 102 upside down may be performed at either the time of being transferred from the first cutter 11B to the first inspector 11C or the time of being transferred from the first inspector 11C to the stack line 20.

In FIGS. 13 to 15, the description may be based on the state in which the second processing line 12 is stopped and the first processing line 11 is operating, but may be applied in a similar manner even when the first processing line 11 is stopped and the second processing line 12 is operated.

According to an embodiment, when the first processing line 11 is stopped, the second processing line 12 may alternately perform an operation of supplying the electrode assembly 100, seated on the second transfer table 12D with the lower surface 100B of the electrode assembly 100 facing upward, to the second welder 12A to manufacture the second-type electrode assembly 102 and an operation of supplying the electrode assembly 100, seated on the second transfer table 12D with the upper surface 100A of the electrode assembly 100 facing upward, to the second welder 12A to manufacture the first-type electrode assembly 101. Also, when the first processing line 11 is stopped, the second processing line 12 may be configured such that the second transfer table 12D on which the electrode assembly 100 is seated with the lower surface facing upward and the second transfer table 12D on which the electrode assembly 100 is seated with the upper surface facing upward have a stopping position different from each other at the second welder 12A and the second cutter 12B. Also, when the first processing line 11 is stopped, the second processing line 12 may supply the first-type electrode assembly 101 upside down in the process of supplying the first-type electrode assembly 101 to the stack line 20.

In the second processing line 12, the electrode assembly 100 may be seated on the second transfer table 12D with its lower surface facing upward and welded at the first position (P1) while passing through the second welder 12A, thereby manufacturing the second-type electrode assembly 102. When the first processing line 11 is stopped, the electrode assembly 100 seated on the second transfer table 12D with its upper surface facing upward in the second processing line 12 may be welded at the first position (P1) while passing through the second welder 12A, thereby becoming the first-type electrode assembly 101. In this case, the second transfer table 12D may be stopped at a fifth position so that the plurality of electrode tabs (T) of the electrode assembly 100 seated with the upper surface facing upward is positioned between the horn 410 and the anvil 420 of the second welder 12A, and the second transfer table 12D may be stopped at a sixth position so that the plurality of electrode tabs (T) of the electrode assembly 100 seated with the lower surface facing upward is positioned between the horn 410 and the anvil 420 of the second welder 12A. The fifth position and the sixth position may be different from each other. After the welding tab (WT) is formed, the second transfer table 12D may be stopped in a manner similar to the stopping at the second welder 12A, such that the welding tab (WT) is positioned between the upper blade 510 and the lower blade 520 of the second cutter 12B. Since the second processing line 12 manufactures the second-type electrode assembly 102 and supplies the same to the stack line 20, the second processing line 12 may supply the first-type electrode assembly 101 upside down to the stack line 20. The stack line 20 may receive the first-type electrode assembly 101 and the second-type electrode assembly 102 in the same direction as when both the first processing line 11 and the second processing line 12 are in a normal state.

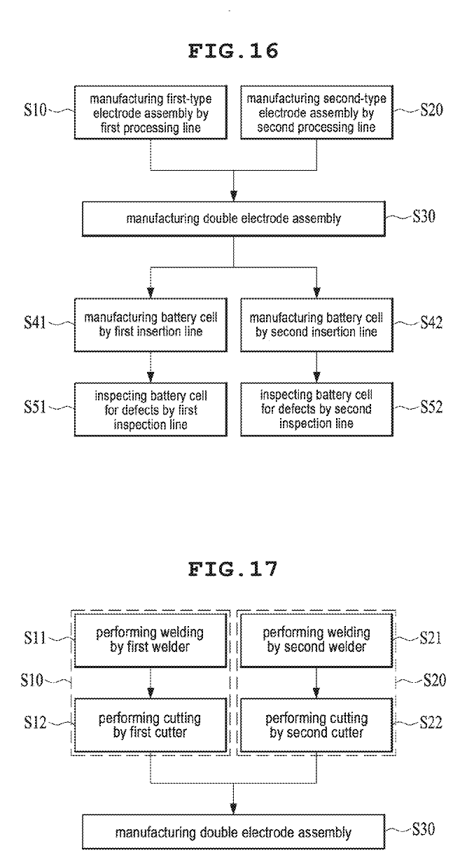

FIG. 16 is a flowchart illustrating each step of an operating method of a layout 1 of a battery cell 300 assembly apparatus according to an embodiment. FIG. 17 is a flowchart illustrating each step of (S10) manufacturing a first-type electrode assembly 101 by a first processing line 11 and (S20) manufacturing a second-type electrode assembly 102 by a second processing line 12 according to an embodiment. FIGS. 1 to 15 are referenced together.

FIGS. 1 and 16 are referred. According to an embodiment, an operating method of a layout 1 of a battery cell 300 assembly apparatus may comprise a step (S10) of manufacturing a first-type electrode assembly 101 by a first processing line 11, a step (S20) of manufacturing a second-type electrode assembly 102 by a second processing line 12 arranged in parallel with the first processing line 11, a step (S30) of manufacturing a double electrode assembly 120 by stacking and fixing, by a stack line 20, the first-type electrode assembly 101 and the second-type electrode assembly 102 output from the first processing line 11 and the second processing line 12, a step (S41) of manufacturing a battery cell 300 by a first insertion line 31 by inserting the double electrode assembly 120 into a case, and a step (S42) of manufacturing the battery cell 300 by a second insertion line 32 arranged in parallel with the first insertion line 31 by inserting the double electrode assembly 120 into the case.

The step (S10) of manufacturing the first-type electrode assembly 101 may manufacture the first-type electrode assembly 101 by supplying the electrode assembly 100 to the first processing line 11 and performing welding, cutting, and inspection. The first-type electrode assembly 101 manufactured in the step (S10) of manufacturing the first-type electrode assembly 101 may be supplied to the stack line 20.

The step (S20) of manufacturing the second-type electrode assembly 102 may manufacture the second-type electrode assembly 102 by supplying the electrode assembly 100 to the second processing line 12 and performing welding, cutting, and inspection. The second-type electrode assembly 102 manufactured in the step (S20) of manufacturing the second-type electrode assembly 102 may be supplied to the stack line 20.

The step (S30) of manufacturing the double electrode assembly 120 may assemble the double electrode assembly 120 by stacking and fixing the first-type electrode assembly 101 and the second-type electrode assembly 102 by the stack line 20. The double electrode assembly 120 manufactured in the step (S30) of manufacturing the double electrode assembly 120 may be distributed to the first insertion line 31 and the second insertion line 32.

The step (S41) of manufacturing the battery cell 300 by the first insertion line 31 and the step (S42) of manufacturing the battery cell 300 by the second insertion line 32 may be simultaneously performed in parallel. The step (S41) of manufacturing the battery cell 300 by the first insertion line 31 and the step (S42) of manufacturing the battery cell 300 by the second insertion line 32 may perform a process of combining the double electrode assembly 120 and a cell cap 210, inserting the double electrode assembly 120 combined with the cell cap 210 into a can 220, and welding the can 220 and the cell cap 210. The battery cell 300 manufactured in the step (S41) of manufacturing the battery cell 300 by the first insertion line 31 may be supplied to the first inspection line 41, and the battery cell 300 manufactured in the step (S42) of manufacturing the battery cell 300 by the second insertion line 32 may be supplied to the second inspection line 42.

According to an embodiment, an operating method of a layout 1 of a battery cell 300 assembly apparatus may further comprise a step of inspecting the battery cell 300 for defects by a first inspection line 41 arranged alongside the first insertion line 31, and a step of inspecting the battery cell 300 for defects by the second inspection line 42 arranged alongside the second insertion line 32 and in parallel with the first inspection line 41.

The step of inspecting the battery cell 300 for defects by the first inspection line 41 and the step of inspecting the battery cell 300 for defects by the second inspection line 42 may be simultaneously performed in parallel.

According to an embodiment, the processing speeds of (S10) manufacturing the first-type electrode assembly 101 and (S20) manufacturing the second-type electrode assembly 102 may be twice the processing speeds of (S41) manufacturing the battery cell 300 by the first insertion line 31 and (S42) manufacturing the battery cell 300 by the second insertion line 32.

The processing speed may be expressed by how many workpieces are manufactured or assembled per minute. As described with reference to FIG. 3, the processing speeds of (S41) manufacturing the battery cell 300 by the first insertion line 31 and (S42) manufacturing the battery cell 300 by the second insertion line 32 may be relatively slow, and the processing speeds of (S10) manufacturing the first-type electrode assembly 101 and (S20) manufacturing the second-type electrode assembly 102 may be relatively fast. The step (S30) of manufacturing the double electrode assembly 120 may prevent a bottleneck phenomenon by distributing the double electrode assembly 120 to the first insertion line 31 and the second insertion line 32.

FIGS. 1 to 6 and 17 are referred. According to an embodiment, the step (S10) of manufacturing the first-type electrode assembly 101 by the first processing line 11 may comprise a step (S11) of performing welding by a first welder 11A at a first position (P1) spaced apart from the first transfer table 11D by a first distance (D1) so as to manufacture the first-type electrode assembly 101 in which a welding tab (WT) is formed at a location closer to the upper surface than the lower surface of the body in a state in which the electrode assembly 100 is seated on the first transfer table 11D with the upper surface 100A of the electrode assembly 100 facing upward, and a step (S12) of performing cutting by a first cutter 11B at the first position (P1) in order to cut the welding tab (WT) to a predetermined length. Also, the step (S20) of manufacturing the second-type electrode assembly 102 by the second processing line 12 may comprise a step (S21) of performing welding by a second welder 12A at the first position (P1) spaced apart from the second transfer table 12D by the first distance (D1) so as to manufacture the second-type electrode assembly 102 in which the welding tab (WT) is formed at a location closer to the lower surface than the upper surface of the body in a state in which the electrode assembly 100 is seated on the second transfer table 12D with the lower surface 100B of the electrode assembly 100 facing upward, and a step (S22) of performing cutting by a second cutter 12B at the first position (P1) in order to cut the welding tab (WT) to a predetermined length.

The step (S11) of performing welding by the first welder 11A and the step (S21) of performing welding by the second welder 12A may be simultaneously performed in parallel. In the step (S11) of performing welding by the first welder 11A, the first welder 11A may weld a plurality of electrode tabs (T) of the electrode assembly 100, seated on the first transfer table 11D with its upper surface facing upward, at the first position (P1) to form the welding tab (WT). In the step (S21) of performing welding by the second welder 12A, the second welder 12A may weld the plurality of electrode tabs (T) of the electrode assembly 100, seated on the second transfer table 12D with its lower surface facing upward, at the first position (P1) to form the welding tab (WT).

The step (S12) of performing cutting by the first cutter 11B and the step (S22) of performing cutting by the second cutter 12B may be simultaneously performed in parallel. In the step (S12) of performing cutting by the first cutter 11B, the first cutter 11B may cut the welding tab (WT) formed at a position close to the upper surface of the first-type electrode assembly 101. In the step (S22) of performing cutting by the second cutter 12B, the second cutter 12B may cut the welding tab (WT) formed at a position close to the lower surface of the second-type electrode assembly 102.

The step (S10) of manufacturing the first-type electrode assembly 101 by the first processing line 11 may further comprise a step of inspecting the first-type electrode assembly 101 by the first inspector 11C. The step (S20) of manufacturing the second-type electrode assembly 102 by the second processing line 12 may further comprise a step of inspecting the second-type electrode assembly 102 by the second inspector 12C. The step of inspecting the first-type electrode assembly 101 by the first inspector 11C and the step of inspecting the second-type electrode assembly 102 by the second inspector 12C may be simultaneously performed in parallel. Any content will be omitted that overlaps with the content already described regarding the operations of the first inspector 11C and the second inspector 12C.

FIGS. 7 and 15 are referred. In the step (S30) of manufacturing the double electrode assembly 120, when the first insertion line 31 is stopped, the stack line 20 may supply the double electrode assembly 120 only to the second insertion line 32, and when the second insertion line 32 is stopped, the stack line 20 may supply the double electrode assembly 120 only to the first insertion line 31.

When the first insertion line 31 or the second insertion line 32 is stopped, the step (S30) of manufacturing the double electrode assembly 120 may supply the double electrode assembly 120 only to a line operating normally. Even when one of the first insertion line 31 or the second insertion line 32 is temporarily stopped due to an inspection or the like, the entire battery assembly apparatus may not be stopped because the other one operates normally.

FIG. 8 and FIG. 15 are referred. When either the first processing line 11 or the second processing line 12 is stopped, the other processing line may be used to alternately manufacture the first-type electrode assembly 101 and the second-type electrode assembly 102.

The step (S10) of manufacturing the first-type electrode assembly 101 by the first processing line 11 may operate to alternately manufacture the first-type electrode assembly 101 and the second-type electrode assembly 102 when the second processing line 12 is stopped, and the step (S20) of manufacturing the second-type electrode assembly 102 by the second processing line 12 may operate to alternately manufacture the second-type electrode assembly 102 and the first-type electrode assembly 101 when the first processing line 11 is stopped.

The following description will be based on a case where the first-type electrode assembly 101 and the second-type electrode assembly 102 are manufactured in the step (S10) of manufacturing the first-type electrode assembly 101 by the first processing line 11. It can be understood that the case where the first-type electrode assembly 101 and the second-type electrode assembly 102 are manufactured in the step (S20) of manufacturing the second-type electrode assembly 102 by the second processing line 12 operates in a similar manner.

First, a method of changing the operation positions of the welder and the cutter will be described.

FIGS. 9 to 12 and 16 are referenced together.

When the second processing line 12 is stopped, the step (S11) of performing welding by the first welder 11A may allow the first welder 11A to alternately perform an operation of performing welding at the first position (P1) to manufacture the first-type electrode assembly 101 and an operation of performing welding at the second position (P2) closer to the transfer table than the first position (P1) to manufacture the second-type electrode assembly 102, and the step (S12) of performing cutting by the first cutter 11B may allow the first cutter 11B to alternately perform an operation of performing cutting at the first position (P1) and an operation of performing cutting at the second position (P2).

In the step (S11) of performing welding by the first welder 11A, the first welder 11A may perform welding at the first position (P1) spaced apart from the first transfer table 11D by the first distance (D1) and form the first-type electrode assembly 101 in which the welding tab (WT) is formed at a position close to the upper surface 100A of the electrode assembly 100. Then, in the next pitch, the first welder 11A may perform welding at the second position (P2) spaced apart from the first transfer table 11D by the second distance (D2) and form the second-type electrode assembly 102 in which the welding tab (WT) is formed at a position close to the lower surface 100B of the electrode assembly 100. In this case, the electrode assembly 100 may be seated on the first transfer table 11D with its upper surface facing upward.

In the step (S12) of performing cutting by the first cutter 11B, the first cutter 11B may perform cutting at the first position (P1), similar to the first welder 11A, and may perform cutting at the second position (P2) in the next pitch. When the first welder 11A and the first cutter 11B operate in this manner, the first-type electrode assembly 101 and the second-type electrode assembly 102 may be manufactured alternately in the first processing line 11.

When the first processing line 11 is stopped, the step (S21) of performing welding by the second welder 12A may allow the second welder 12A to alternately perform an operation of performing welding at the first position (P1) to manufacture the second-type electrode assembly 102 and an operation of performing welding at the second position (P2) closer to the transfer table than the first position (P1) to manufacture the first-type electrode assembly 101, and the step (S22) of performing cutting by the second cutter 12B may allow the second cutter 12B to alternately perform an operation of performing cutting at the first position (P1) and an operation of performing cutting at the second position (P2).

In the step (S21) of performing welding by the second welder 12A, the second welder 12A may perform welding at the first position (P1) spaced apart from the second transfer table 12D by the first distance (D1) and form the second-type electrode assembly 102 in which the welding tab (WT) is formed at a position close to the lower surface 100B of the electrode assembly 100. Then, in the next pitch, the second welder 12A may perform welding at the second position (P2) spaced apart from the second transfer table 12D by the second distance (D2) and form the first-type electrode assembly 101 in which the welding tab (WT) is formed at a position close to the upper surface 100A of the electrode assembly 100. In this case, the electrode assembly 100 may be seated on the second transfer table 12D with its lower surface facing upward.

In the step (S22) of performing cutting by the second cutter 12B, the second cutter 12B may perform cutting at the first position (P1), similar to the second welder 12A, and may perform cutting at the second position (P2) in the next pitch. When the second welder 12A and the second cutter 12B operate in this manner, the second-type electrode assembly 102 and the first-type electrode assembly 101 may be alternately manufactured in the second processing line 12.

Next, a method of changing a direction in which the electrode assembly 100 is seated on the transfer table will be described.

FIGS. 13 to 15 and 17 are referred.

When the second processing line 12 is stopped, the step (S11) of performing welding by the first welder 11A may alternately perform an operation of supplying the electrode assembly 100, seated on the first transfer table 11D with the upper surface 100A of the electrode assembly 100 facing upward, to the first welder 11A to manufacture the first-type electrode assembly 101 and an operation of supplying the electrode assembly 100, seated on the first transfer table 11D with the lower surface 100B of the electrode assembly 100 facing upward, to the first welder 11A to manufacture the second-type electrode assembly 102.

A direction in which the upper surface 100A of the electrode assembly 100 faces may be differently seated on the first transfer table 11D for each pitch, either upward or downward. Even when the first welder 11A and the first cutter 11B continue to operate at the first position (P1), the position of the welding tab (WT) formed on the electrode assembly 100 may be formed closer to the upper surface or closer to the lower surface.

When the second processing line 12 is stopped, the step (S10) of manufacturing the first-type electrode assembly 101 by the first processing line 11 may set the first transfer table 11D on which the electrode assembly 100 is seated with its upper surface facing upward and the first transfer table 11D on which the electrode assembly 100 is seated with its lower surface facing upward to have a stopping position different from each other at the first welder 11A and the first cutter 11B.

In FIG. 15, the top view of the first welder 11A illustrates a state in which the electrode assembly 100 is transferred by the first transfer table 11D and stopped at a predetermined position in a state in which the horn 410 and the anvil 420 are spaced apart from each other. In FIG. 15, a side view of the first welder 11A illustrates a state in which the horn 410 and the anvil 420 perform welding.

Positions of the plurality of electrode tabs (T) may be different in a state in which the upper surface 100A of the electrode assembly 100 faces upward on the first transfer table 11D and in a state in which the lower surface 100B of the electrode assembly 100 faces upward. In this case, the first transfer table 11D may stop at the third position (P3) such that the plurality of electrode tabs (T) of the electrode assembly 100 with its upper surface facing upward are stopped at a predetermined position of the first welder 11A, and the first transfer table 11D may stop at the fourth position (P4) such that the plurality of electrode tabs (T) of the electrode assembly 100 with its lower surface facing upward are stopped at a predetermined position of the first welder 11A. In a similar manner, the position at which the first transfer table 11D is stopped at the first cutter 11B may also be different. A difference (D3) between the third position (P3) and the fourth position (P4) may correspond to a difference in the positions of the welding tabs (WT) of the first-type electrode assembly 101 and the second-type electrode assembly 102.

The first welder 11A may perform welding at the first position (P1) spaced apart from the first transfer table 11D by the first distance (D1). When the first welder 11A performs welding, the electrode assembly 100 with its upper surface 100A facing upward may become the first-type electrode assembly 101, and the electrode assembly 100 with its lower surface 100B facing upward may become the second-type electrode assembly 102.

When the second processing line 12 is stopped, the step (S10) of manufacturing the first-type electrode assembly 101 by the first processing line 11 may supply the second-type electrode assembly 102 upside down in the process of supplying the second-type electrode assembly 102 to the stack line 20.

The first processing line 11 may supply the first-type electrode assembly 101 with the upper surface facing upward to the stack line 20. Since the second-type electrode assembly 102 manufactured in the first processing line 11 has its lower surface facing upward, the second-type electrode assembly 102 may be flipped over so that the upper surface 100A faces upward. The operation of flipping the second-type electrode assembly 102 may be performed at any one of a timing when the second-type electrode assembly 102 is supplied to the first inspector 11C and a timing when the second-type electrode assembly 102 is supplied from the first inspector 11C to the stack line 20.

When the first processing line 11 is stopped, the step (S21) of performing welding by the second welder 12A may alternately perform an operation of supplying the electrode assembly 100, seated on the second transfer table 12D with the lower surface 100B of the electrode assembly 100 facing upward, to the second welder 12A to manufacture the second-type electrode assembly 102 and an operation of supplying the electrode assembly 100, seated on the second transfer table 12D with the upper surface 100A of the electrode assembly 100 facing upward, to the second welder 12A to manufacture the first-type electrode assembly 101.

A direction in which the lower surface 100B of the electrode assembly 100 faces may be differently seated on the second transfer table 12D for each pitch upward or downward. Even when the second welder 12A and the second cutter 12B continue to operate at the first position (P1), the position of the welding tab (WT) formed in the electrode assembly 100 may be formed close to the lower surface or close to the upper surface.

When the first processing line 11 is stopped, the step (S20) of manufacturing the second-type electrode assembly 102 by the second processing line 12 may set the second transfer table 12D on which the electrode assembly 100 is seated with its lower surface facing upward and the second transfer table 12D on which the electrode assembly 100 is seated with its upper surface facing upward to have a stopping position different from each other at the second welder 12A and the second cutter 12B.

The positions of the plurality of electrode tabs (T) may be different in a state in which the lower surface 100B of the electrode assembly 100 faces upward on the second transfer table 12D and in a state in which the upper surface 100A of the electrode assembly 100 faces upward. In this case, the second transfer table 12D may be stopped at the fifth position so that the plurality of electrode tabs (T) of the electrode assembly 100 with its lower surface facing upward is stopped at a predetermined position of the second welder 12A, and the second transfer table 12D may be stopped at the sixth position so that the plurality of electrode tabs (T) of the electrode assembly 100 with its upper surface facing upward is stopped at a predetermined position of the second welder 12A. In a similar manner, the position at which the second transfer table 12D is stopped on the second cutter 12B may also be different.

When the first processing line 11 is stopped, the step (S20) of manufacturing the second-type electrode assembly 102 by the second processing line 12 may supply the first-type electrode assembly 101 upside down in the process of supplying the first-type electrode assembly 101 to the stack line 20.

The second processing line 12 may supply the second-type electrode assembly 102 with its lower surface facing upward to the stack line 20. Since the first-type electrode assembly 101 manufactured in the second processing line 12 has the upper surface facing upward, the first-type electrode assembly 101 may be flipped over so that the lower surface 100B faces upward. The operation of flipping the first-type electrode assembly 101 may be performed at any one of a timing when the first-type electrode assembly 101 is supplied to the second inspector 12C and a timing when the first-type electrode assembly 101 is supplied from the second inspector 12C to the stack line 20.

The present disclosure has been described in detail with reference to specific exemplary embodiments. The above description is merely an example in which the principle of the present disclosure is applied, and other configurations may be further comprised without departing from the scope of the present disclosure.

What is claimed is:

1. A layout of a battery cell assembly apparatus, the layout comprising:
a first processing line for manufacturing a first-type electrode assembly;
a second processing line for manufacturing a second-type electrode assembly;
a stack line for manufacturing a double electrode assembly by stacking and fixing the first-type electrode assembly and the second-type electrode assembly output from the first processing line and the second processing line;
a first insertion line for manufacturing a battery cell by inserting the double electrode assembly into a case; and
a second insertion line for manufacturing a battery cell by inserting the double electrode assembly into a case,
wherein the first processing line and the second processing line are arranged in parallel with each other, and the first insertion line and the second insertion line are arranged in parallel with each other in order to reduce a length of an entire line.

2. The layout of claim 1, wherein processing speeds of the first processing line and the second processing line are twice the processing speeds of the first insertion line and the second insertion line.

3. The layout of claim 1, further comprising:
a first inspection line arranged alongside the first insertion line for inspecting the battery cell for a defect; and
a second inspection line arranged alongside the second insertion line and arranged in parallel with the first inspection line for inspecting the battery cell for a defect.

4. The layout of claim 1, wherein the first processing line comprises:
a first welder for performing welding at a first position spaced apart from a first transfer table by a first distance to manufacture the first-type electrode assembly in a state in which an electrode assembly is seated on the first transfer table with an upper surface of the electrode assembly facing upward so that a welding tab is formed at a location closer to an upper surface than a lower surface of a body; and
a first cutter for performing cutting at the first position in order to cut the welding tab to a predetermined length, and
the second processing line comprises:
a second welder for performing welding at the first position spaced apart from a second transfer table by the first distance to manufacture the second-type electrode assembly in a state in which the electrode assembly is seated on the second transfer table with a lower surface of the electrode assembly facing upward so that the welding tab is formed at a location closer to the lower surface than the upper surface of the body; and
a second cutter for performing cutting at the first position in order to cut the welding tab to the predetermined length.

5. The layout of claim 1, wherein the stack line
supplies the double electrode assembly only to the second insertion line when the first insertion line is stopped, and
supplies the double electrode assembly only to the first insertion line when the second insertion line is stopped.

6. The layout of claim 1, wherein when one of the first processing line or the second processing line is stopped, the other one operates to alternately manufacture the first-type electrode assembly and the second-type electrode assembly.

7. The layout of claim 4, wherein when the second processing line is stopped, the first processing line
allows the first welder to alternately perform an operation of performing welding at the first position to manufacture the first-type electrode assembly and an operation of performing welding at a second position closer to the transfer table than the first position to manufacture the second-type electrode assembly and
allows the first cutter to alternately perform an operation of performing cutting at the first position and an operation of performing cutting at the second position, and
when the first processing line is stopped, the second processing line
allows the second welder to alternately perform an operation of performing welding at the first position to manufacture the second-type electrode assembly and an operation of performing welding at the second position closer to the transfer table than the first position to manufacture the first-type electrode assembly and
allows the second cutter to alternately perform an operation of performing cutting at the first position and an operation of performing cutting at the second position.

8. The layout of claim 4, wherein when the second processing line is stopped,
the first processing line alternately performs an operation of supplying the electrode assembly, seated on the first transfer table with the upper surface of the electrode assembly facing upward, to the first welder to manufacture the first-type electrode assembly and an operation of supplying the electrode assembly, seated on the first transfer table with the lower surface of the electrode assembly facing upward, to the first welder to manufacture the second-type electrode assembly, and
when the first processing line is stopped,
the second processing line alternately performs an operation of supplying the electrode assembly, seated on the second transfer table with the lower surface of the electrode assembly facing upward, to the second welder to manufacture the second-type electrode assembly and an operating of supplying the electrode assembly, seated on the second transfer table with the upper surface of the electrode assembly facing upward, to the second welder to manufacture the first-type electrode assembly.

9. The layout of claim 8, wherein when the second processing line is stopped,
the first processing line sets the first transfer table on which the electrode assembly is seated with its upper surface facing upward and the first transfer table on which the electrode assembly is seated with its lower surface facing upward to have a stopping position different from each other in the first welder and the first cutter, and
when the first processing line is stopped,
the second processing line sets the second transfer table on which the electrode assembly is seated with its lower surface facing upward and the second transfer table on which the electrode assembly is seated with its upper surface facing upward to have a stopping position different from each other at the second welder and the second cutter.

10. The layout of claim 9, wherein when the second processing line is stopped,
the first processing line supplies the second-type electrode assembly upside down in the process of supplying the second-type electrode assembly to the stack line, and
when the first processing line is stopped,
the second processing line supplies the first-type electrode assembly upside down in the process of supplying the first-type electrode assembly to the stack line.

11. An operating method of a layout of a battery cell assembly apparatus, the method comprising:
manufacturing a first-type electrode assembly by a first processing line;
manufacturing a second-type electrode assembly by a second processing line arranged in parallel with the first processing line;
manufacturing a double electrode assembly by a stack line by stacking and fixing the first-type electrode assembly and the second-type electrode assembly output from the first processing line and the second processing line;
manufacturing a battery cell by a first insertion line by inserting the double electrode assembly into a case; and
manufacturing a battery cell by a second insertion line arranged in parallel with the first insertion line by inserting the double electrode assembly into a case.

12. The method of claim 11, wherein processing speeds of manufacturing the first-type electrode assembly and manufacturing the second-type electrode assembly are twice the processing speeds of manufacturing the battery cell by the first insertion line and manufacturing the battery cell by the second insertion line.

13. The method of claim 11, further comprising:
inspecting the battery cell for a defect by a first inspection line arranged alongside the first insertion line; and
inspecting the battery cell for a defect by a second inspection line arranged alongside the second insertion line and arranged in parallel with the first inspection line.

14. The method of claim 11, wherein manufacturing the first-type electrode assembly by the first processing line comprises:
performing welding at a first position spaced apart from a first transfer table by a first distance to manufacture the first-type electrode assembly in a state in which an electrode assembly is seated on the first transfer table with an upper surface of the electrode assembly facing upward so that a welding tab is formed at a location closer to an upper surface than a lower surface of a body; and
performing cutting at the first position by a first cutter in order to cut the welding tab to a predetermined length, and
manufacturing the second-type electrode assembly by the second processing line comprises:
performing welding at the first position spaced apart from a second transfer table by the first distance to manufacture the second-type electrode assembly in a state in which the electrode assembly is seated on the second transfer table with a lower surface of the electrode assembly facing upward so that the welding tab is formed at a location closer to the lower surface than the upper surface of the body; and
performing cutting at the first position by a second cutter in order to cut the welding tab to a predetermined length.

15. The method of claim 11, wherein manufacturing the double electrode assembly
allows the stack line to supply the double electrode assembly only to the second insertion line when the first insertion line is stopped, and
allows the stack line to supply the double electrode assembly only to the first insertion line when the second insertion line is stopped.

16. The method of claim 11, wherein when the second processing line is stopped
manufacturing the first-type electrode assembly by the first processing line operates to alternately manufacture the first-type electrode assembly and the second-type electrode assembly, and when the first processing line is stopped
manufacturing the second-type electrode assembly by the second processing line operates to alternately manufacture the second-type electrode assembly and the first-type electrode assembly.

17. The method of claim 14, wherein when the second processing line is stopped,
performing welding by the first welder allows the first welder to alternately perform an operation of performing welding at the first position to manufacture the first-type electrode assembly and an operation of performing welding at a second position closer to the transfer table than the first position to manufacture the second-type electrode assembly and
performing cutting by the first cutter allows the first cutter to alternately perform an operation of performing cutting at the first position and an operation of performing cutting at the second position, and
when the first processing line is stopped,
performing welding by the second welder allows the second welder to alternately perform an operation of performing welding at the first position to manufacture the second-type electrode assembly and an operation of performing welding at the second position closer to the transfer table than the first position to manufacture the first-type electrode assembly and
performing cutting by the second cutter allows the second cutter to alternately perform an operation of performing cutting at the first position and an operation of performing cutting at the second position.

18. The method of claim 14, wherein when the second processing line is stopped,
performing welding by the first welder alternately performs an operation of supplying the electrode assembly, seated on the first transfer table with the upper surface of the electrode assembly facing upward, to the first welder to manufacture the first-type electrode assembly and an operation of supplying the electrode assembly, seated on the first transfer table with the lower surface of the electrode assembly facing upward, to the first welder to manufacture the second-type electrode assembly, and
when the first processing line is stopped,
performing welding by the second welder alternately performs an operation of supplying the electrode assembly, seated on the second transfer table with the lower surface of the electrode assembly facing upward, to the second welder to manufacture the second-type electrode assembly and an operating of supplying the electrode assembly, seated on the second transfer table with the upper surface of the electrode assembly facing upward, to the second welder to manufacture the first-type electrode assembly.

19. The method of claim 18, wherein when the second processing line is stopped,
manufacturing the first-type electrode assembly by the first processing line sets the first transfer table on which the electrode assembly is seated with the upper surface facing upward and the first transfer table on which the electrode assembly is seated with the lower surface facing upward to have a stopping position different from each other in the first welder and the first cutter, and
when the first processing line is stopped,
manufacturing the second-type electrode assembly by the second processing line sets the second transfer table on which the electrode assembly is seated with the lower surface facing upward and the second transfer table on which the electrode assembly is seated with the upper surface facing upward to have a stopping position different from each other at the second welder and the second cutter.

20. The method of claim 19, wherein when the second processing line is stopped,
manufacturing the first-type electrode assembly by the first processing line supplies the second-type electrode assembly upside down in the process of supplying the second-type electrode assembly to the stack line, and
when the first processing line is stopped,
manufacturing the second-type electrode assembly by the second processing line supplies the first-type electrode assembly upside down in the process of supplying the first-type electrode assembly to the stack line.
